(19) United States
(12) Patent Application Publication
(10) Pub. No.: US 2009/0074881 A1
(43) Pub. Date: Mar. 19, 2009

(54) Antimicrobial cidality formulations with residual efficacy, uses thereof, and the preparation thereof

(75) Inventor: Andrew J. Kielbania, JR., Chalfont, PA (US)

Correspondence Address: GEARHART LAW, LLC, 4 FERNDALE ROAD, CHATHAM, NJ, 07928, US

(73) Assignee: BIONEUTRAL LABORATORIES CORPORATION USA, Newark, NJ (US)

(21) Appl. No.: 12/290,918

(22) Filed: Nov. 5, 2008

Related U.S. Application Data
(63) Continuation-in-part of application No. 11/746,975, filed on May 10, 2007.
Application No. 11/746,975 is a continuation-in-part of application No. 11/381,269, filed on May 2, 2006.

(51) Int. Cl. A01N 59/00; A01N 37/02; A01N 59/16

(52) U.S. Cl. 424/616; 514/574; 424/618

(57) ABSTRACT

The present invention is a quick-kill formulation that is able to kill organisms such as bacteria, viruses, fungi, mold, spore-forming bacteria and combinations thereof. In addition, the formulation contains a residual kill component that is effective for at least one day. The unique formulation is effective without being corrosive. This is an advantage that allows it to be used in a wide range of applications, one application being in the medical field for sterilizing instruments. Another improvement of this formulation over the prior art is that it is stabilized such that, unlike prior art formulations, tap water, as opposed to distilled water, may be used in its manufacture.

### PRIORITY APPLICATION DATA

This application is a continuation in part of U.S. Ser. No. 11/746,975 filed on May 10, 2007, which is a continuation in part of application Ser. No. 11/381,269 filed on May 2, 2006, all of which are incorporated herein by reference.

### FIELD OF THE INVENTION

The present invention relates to chemical formulations that possess anti-bacterial, antiviral and anti-fungal properties which are not corrosive, and facile methods of making and using those formulations.

### BACKGROUND OF THE INVENTION

Bacteria, viruses and fungi, e.g., mold, are a major source of disease and contamination throughout modern society. The need to control the growth of these micro-organisms is paramount for maintaining public health as well as reducing costly commercial and industrial contamination. In the case of bacteria, infections and contaminations are effected by both Gram-positive (e.g., Staphylococcus aureus) and Gram-negative (e.g., Escherichia coli) bacteria. Many anti-bacterial agents are limited in their efficacy to only one of those two classes of bacteria. Moreover, known anti-viral agents are often effective only against enveloped or non-enveloped viruses, but not both.

While numerous anti-microbial agents exist, they have limitations and there continues to be a search for further improvements. To date antimicrobial formulations have drawbacks or undesirable properties associated with them which limits their ease of manufacture and include issues with availability of ingredients, ease of use, utility with broad spectrum efficacy, or result in negative impact on the items being treated, negative impact on individuals using them or being treated, or the environment in general. These drawbacks in today's world are limiting the utility of existing antimicrobial formulations. Examples of the prior art upon which these antimicrobial formulations are based and their drawbacks or disadvantages include:

Alcohol and alcohol gels; the problems associated with these products are that they lose effectiveness upon dilution, have limited cidal activity and are flammable. They are not effective against spores or biofilms. Efficacy is quickly lost with rapid drying, and there is no residual efficacy.

Hypochlorite: disadvantages include its odor, harshness, corrosiveness, and its destruction of protective coatings and synthetic materials such as floors and walls and table tops; hypochlorite also has a short shelf life. It is not environmentally friendly and reacts with many organic materials to produce carcinogens, and is inactivated by organic material.

Gluteraldehyde and orthophthalaldehyde: disadvantages are toxicity, a disagreeable odor, and that they cause eye, nose, lung and throat irritation. Their use is limited to specially designated and specially constructed areas/equipment.

Iodophors: disadvantages include severely staining virtually any surface, volatility and rapid loss of efficacy at modest temperatures, ie: room temperature and above, and the fact they are not consistently sporocidal or effective against biofilms. Their efficacy is also rapidly interfered with by proteins.

Chlorhexidine gluconate is deactivated by anionic surfactants (typically used in laundry detergents) and inorganic anions, making it difficult to use and limiting efficacy.

Hexachlorophene has limited use as it is only effective against gram positive organisms, and has no broad spectrum efficacy. It is also a neurotoxin.

Halogenated phenolics have a low degree of efficacy, especially against viruses and fungi, poor surface cleaning capabilities and environmental concerns since they are difficult to degrade. Efficacy is inhibited by anionic surfactants.

Triclosan is not effective against spores and has only moderate bactericidal activity which limits its utility. It also raises environmental concerns and there is regulatory pressure to eliminate its use.

Chlorine dioxide is a toxic gas that requires complex, special and capital intensive equipment and trained personnel to generate and apply it. It is unstable in moist air and water. Concentrations in air must be limited because of the explosive hazard. Starting materials are hazardous and fire hazards. It is used only in special situations, and it must be contained.

Ethylene oxide is a reactive, flammable gas that is irritating to skin and lungs, is a carcinogen, mutagen, sensitizer and must be used with specialty equipment and trained personnel. It can react violently with many common materials found in health care situations. It must be contained.

Quats are not effective against spores, gram negative bacterial, biofilms and certain viruses; they exhibit narrow antimicrobial activity. They foster resistance upon repeated use. They are deactivated by anionic material.

Phenolics are not acceptable in food handling areas, and are easily absorbed through an individual's skin with adverse effects. Repeated use on synthetic materials degrades them and makes them sticky. They are not widely accepted for use.

Silver requires special processes and equipment to properly incorporate it into an antimicrobial formulation. Ubiquitous ions such as chloride ion precipitate silver out of solution requiring the use of purified water in the preparation of silver containing antimicrobials. It has limited efficacy and is not effective against spores or biofilms, is degraded by light and can stain surfaces at certain concentrations. Many silver salts have limited water solubility.

Hydrogen peroxide is not a broad spectrum anti-microbial and is not effective against spores. It is corrosive to most metals including copper, iron, zinc and aluminum. It has no residual efficacy. It has limited stability.

Peracetic acid is harsh and very corrosive to metals and skin. It is difficult to stabilize and requires the use of purified water in the preparation of antimicrobial formulations. It has limited residual efficacy because of evaporation and degradation.

Thus, as can be seen from the above list of common antimicrobials and their drawbacks and disadvantages there has been a long standing need for an antimicrobial that is easy to prepare or manufacture, uses readily available chemical components, is stable, particularly one package stable, is easy to use or apply, is a rapid acting broad spectrum antimicrobial that is bactericidal, fungicidal, mycobactericidal, viricidal, protozoacidal, sporocidal, and eradicates biofilms. The antimicrobial also must not be detrimental to individuals using it, it must leave no toxic residues, must not be detrimental to materials of construction for the items, articles and surfaces being treated, and in addition must have residual activity to prevent the rapid reoccurrence of harmful microorganisms on the items, articles or surfaces that have been treated. The need for residual activity is especially required in the eradication of mold and the prevention of the reoccurrence of mold growth after initial cleaning. In addition the antimicrobial formulation should not have a negative impact on the environment.

This appears to be an overwhelming or daunting list of required attributes for an antimicrobial formulation and from reviewing the prior art seems unachievable. However, the present invention embodies all of these attributes in an antimicrobial formulation which is far beyond the current state of the art. As used herein, unless otherwise indicated, the following terms mean:

“Microbe(s)” includes bacteria, viruses, fungi, mold, and spore-forming bacteria.

“Inhibit” means substantially stopping the growth of a Microbe(s).

“Kill” means substantially causing the death of a Microbe(s).

“Anti-microbial agent(s)” means a compound or composition which in liquid, solid or gaseous form, inhibits or kills microbes.

“CFU” means ‘colony forming unit’ and is used to measure efficacy two ways: 1) by how many cfus are killed within a period of time after treatment with a formulation, and 2) by how long it takes cfus to repopulate after treatment with a formulation.

### SUMMARY OF THE INVENTION

The present invention is a composition with a quick kill component, wherein the quick kill component is able to kill organisms selected from the group consisting of bacteria, viruses, fungi, mold, spore-forming bacteria and combinations thereof, and a residual kill component, wherein the residual kill component has a residual efficacy against spores for at least one day.

The present invention generally relates to anti-microbial formulations and methods of their use and production. The formulations of the present invention are effective as broad spectrum anti-bacterial agents with efficacy against both Gram-negative and Gram-positive bacteria, as anti-viral agents with efficacy against both enveloped and non-enveloped viruses, anti fungal agents and anti spore forming agents and with efficacy against biofilms.

The present invention is unique and is more effective in disease prevention than other anti-microbials currently available. As can be seen from the data presented here-in, the present invention has the advantage of being a formulation that kills a wide spectrum of disease-causing entities, has relatively long-lasting efficacy, and has the added advantage of being non-corrosive. The latter is extremely important in terms of being safe to use around living things, and also in the medical field in the area of instrument sterilization.

In the present invention, the quick kill component is preferably a quick kill component. The quick kill component of the present invention includes at least one surfactant, at least one acid, at least one peroxide (preferably hydrogen peroxide), and a peracid (preferably peracetic acid). The residual kill component has at least one source of silver (preferably silver ion or salt), or boron or a copper salt and water. The composition may has have at least one at least one water soluble solvent. The anti-microbial formulations of the present invention may additionally contain an organic salt. The organic salt may be a salt of the same acid that is used in the formulation or a salt of a different acid. The anti-microbial formulations of the present invention may additionally contain an inorganic salt. Other additives may be used to enhance specific properties, such as but not limited to, wetting agents, peroxy stabilizers, thickeners or rheology modifiers, metal salts of weak acids, fillers, dyes or colorants, perfume or fragrances, corrosion inhibitors, additives to enhance mildness to skin, or any other additives which improve the product in any way and/or give it enhanced properties.

A preferred embodiment of the invention is an anti-microbial composition with a quick kill component, where the quick kill component preferably has: at least one surfactant present in a concentration from about 0.01% to about 80% by weight, an acid or acid salt present in a concentration from about 0.01% to about 20% by weight, at least one peroxide in a concentration from about 0.01% to about 55%, at least one peracid in a concentration from about 0.01% to about 30%. The composition also has a a residual kill component of at least one of silver, copper or boron, or combinations thereof, in a concentration of from about 0.01% to about 10%, and the balance water. Optionally the at least one water soluble solvent in a concentration from about 0.01% to about 20% is present.

In the present invention the surfactant provides wetting for the quick kill components and stability for the residual kill components. The quick kill components are peroxy based chemicals which are usually very corrosive but in the formulations of the present invention they are not. The residual kill components are not as powerful an antimicrobial agent as the quick kill components but when combined in the present invention provide excellent residual efficacy against even very difficult to kill spore forms of microorganism, such as aspergillus niger.

Other embodiments of the formulation may have the general formulation detailed above, with the following modifications: 1) a surfactant that is dodecylbenzene sulfonic acid in a concentration of about 0.1% to about 2%; and/or 2) an acid that is citric acid in a concentration of 0.01% to 5.0%; and/or 3) the peroxide is hydrogen peroxide in a concentration from about 1.0% to 10.0%; and/or 4) the at least one source of silver, boron or copper salt is silver, and the concentration is from about 1000 ppm to 0.5% of silver nitrate; and/or 5) the at least one source of silver, boron or copper salt or combination thereof is from about 1000 parts per million (ppm) to about 0.5% of silver nitrate and about 2.0% to about 6% boric acid; and/or 6) wherein the peracid is peric acid in a concentration of about 0.05% to 6.0%; and/or 7) wherein the composition includes a wetting agent; and/or 8) wherein the water is tap water.

One preferred embodiment is the general formulation outlined above, with concentrations of about 0.1% dodecylbenzene sulfonic acid, about 2% citric acid, about 2% hydrogen peroxide, about 0.6% peracetic acid and about 1000 ppm silver nitrate.

Another preferred embodiment is the general formulation outlined above, with concentrations of about 0.1% dodecylbenzene sulfonic acid, about 3% citric acid, about 3% hydrogen peroxide, about 3% peracetic acid and about 1000 ppm silver nitrate.

Another preferred embodiment is the general formulation outlined above, with concentrations of about 2% dodecylbenzene sulfonic acid, about 0.1% citric acid, about 2% hydrogen peroxide, about 0.6% peracetic acid and about 1000 ppm silver nitrate.

Another preferred embodiment is the general formulation outlined above, with concentrations of about 0.5% dodecylbenzene sulfonic acid, about 0.01% citric acid, about 9.3% hydrogen peroxide, about 0.6% peracetic acid, about 0.2% benzoic acid, about 4% boric acid, about 10% butyl cellusolve and about 0.5% silver nitrate.

Another preferred embodiment is the general formulation outlined above, with concentrations of about 0.5% dodecylbenzene sulfonic acid, about 0.01% citric acid, about 9.3% hydrogen peroxide, about 0.6% peracetic acid, about 0.2% benzoic acid, about 4% boric acid, about 10% butyl cellusolve and about 0.1% silver nitrate.

Another preferred embodiment is the general formulation outlined above, with concentrations of about 0.1% dodecylbenzene sulfonic acid, about 0.01% citric acid, about 9.0% hydrogen peroxide, about 0.6% peracetic acid, about 0.3% benzoic acid, about 5.0% boric acid, and about 10% butyl cellusolve

Another preferred embodiment is the general formulation outlined above, with concentrations of about 0.1% dodecylbenzene sulfonic acid, about 0.01% citric acid, about 9.0% hydrogen peroxide, about 0.6% peracetic acid, about 0.3% benzoic acid, about 10% butyl cellusolve and about 0.5% silver nitrate.

Another preferred embodiment is the general formulation outlined above, with concentrations of about 0.1% dodecylbenzene sulfonic acid, about 0.01% citric acid, about 9.0% hydrogen peroxide, about 0.6% peracetic acid, about 0.30% benzoic acid, about 5.0% boric acid, about 10.0% butyl cellusolve and about 0.5% silver nitrate.

Another preferred embodiment is the general formulation outlined above, with concentrations of about 0.1% dodecylbenzene sulfonic acid, about 4.3% citric acid, about 5.2% hydrogen peroxide, about 0.5% peracetic acid, and about 0.006% silver nitrate.

The formulations are such that the amount of anti-microbial agent is effective to exhibit a time to kill of 5 minutes or less and preferably a time to kill of 1 minute or less against each of Staphylococcus aureus ATCC 6538, Escherichia coli ATCC 8739 when diluted 1 to 2 with a 4% human protein broth, and has a residual efficacy after drying to prevent the repopulation of a surfaced treated with the antimicrobial agent against Staphylococcus aureus or Escherichia coli.

The formulations of the present invention have residual efficacy against aspergillus niger spores for at least 1 day. It is preferred that the formulations of the present invention have residual efficacy against aspergillus niger spores for at least 2 days. It is most preferred that the formulations of the present invention have residual efficacy against aspergillus niger spores for at least 3 days. It has been shown (examples 91, 95, 96, 104 described later in the text) that there is residual efficacy, in some cases for up to 6 days (example 104).

An important feature of one embodiment of the present invention is related to the use of four individually corrosive components of an antimicrobial formulation which when combined correctly, in accordance with the invention antimicrobial formulation, provide a noncorrosive formulation, especially one which is noncorrosive to ferrous metals. The antimicrobial formulation is stable, easy to use, rapid acting and has broad spectrum efficacy.

Another embodiment of the present invention is related to the use of four individually corrosive components of an antimicrobial formulation which when combined correctly with silver, in accordance with the invention, into an antimicrobial formulation provide a noncorrosive formulation, especially one which is noncorrosive to ferrous metals and yellow metals such as copper, brass and bronze. The antimicrobial formulation is stable, easy to use, rapid acting and has broad spectrum efficacy.

Another embodiment of the present invention is related to the use of four individually corrosive components of an antimicrobial formulation which when combined correctly with silver, in accordance with the invention, into an antimicrobial formulation provide a noncorrosive formulation, especially one which is noncorrosive to ferrous metals and yellow metals such as copper, brass and bronze and aluminum and stainless steel, and provides a peracetic acid antimicrobial with residual efficacy.

The formulations of the present invention have residual efficacy against aspergillus niger spores for at least 1 day. It is preferred that the formulations of the present invention have residual efficacy against aspergillus niger spores for at least 2 days. It is most preferred that the formulations of the present invention have residual efficacy against aspergillus niger spores for at least 3 days. It has been shown (examples 91, 95, 96, 104 described later in the text) that there is residual efficacy, in some cases for up to 6 days (example 104).

It should be recognized by those skilled in the art that Aspergillus niger spores are difficult to eradicate, and it is also difficult to maintain a surface free of Aspergillus niger. An antimicrobial formulation that can eradicate Aspergillus niger spores will have similar efficacy against vegetative bacteria and viruses.

Another embodiment of the present invention is related to the use of four individually corrosive components of an antimicrobial formulation which when combined correctly with silver, in accordance with the invention, into an antimicrobial formulation provide a noncorrosive formulation, especially one which is noncorrosive to ferrous metals and yellow metals such as copper, brass and bronze and provide a silver antimicrobial which is sporicidal and has residual efficacy against spores. The formulations of the present invention have residual efficacy against aspergillus niger spores for at least 1 day. It is preferred that the formulations of the present invention have residual efficacy against aspergillus niger spores for at least 2 days. It is most preferred that the formulations of the present invention have residual efficacy against aspergillus niger spores for at least 3 days.

The present invention is a formulation that is easy to prepare or manufacture, stable, easy to use or apply, and is a rapid acting broad spectrum antimicrobial. It is bactericidal, fungicidal, mycobactericidal, viricidal, protozoacidal, sporocidal, and eradicates biofilms. This antimicrobial is not detrimental to individuals using it, leaves no toxic residues, is not detrimental to materials of construction for the items, articles and surfaces being treated, and in addition has residual activity to prevent the rapid reoccurrence of harmful microorganisms on the items, articles or surfaces that have been treated. An additional advantage is that the antimicrobial formulation does not have a negative impact on the environment.

### DESCRIPTION OF THE PREFERRED EMBODIMENTS

In the present invention the surfactant provides wetting for the quick kill components and stability for the residual kill components. The quick kill components are peroxy based chemicals which are usually very corrosive but in the formulations of the present invention they are not. The residual kill components are not as powerful an antimicrobial agent as the quick kill components but when combined in the present invention provide excellent residual efficacy against even very difficult to kill spore forms of microorganism, such as aspergillus niger.

The present invention broadly relates to anti-microbial compositions containing: 1) at least one surfactant; 2) at least one acid; 3) at least one peroxide (preferably hydrogen peroxide); 4) at least one peracid, preferably peracetic acid; 5) silver (silver ion or salt, optionally a boron or copper salt and/or compound); and 6) optionally at least one water soluble solvent, and 7) water. Optional compounds include an organic salt, which. may be a salt of the same acid that is used in the formulation or a salt of a different acid; an inorganic salt, which may be the same as the silver salt or a different inorganic salt. Other additives may be used to enhance specific properties, such as but not limited to, wetting agents, peroxy stabilizers, thickeners or rheology modifiers, metal salts of weak acids, fillers, dyes or colorants, perfume or fragrances, corrosion inhibitors, additives to enhance mildness to skin, or any other additives which improve the product in any way and/or give it enhanced properties.

The formulations of the present invention include a surfactant from about 0.01% to a concentration of about 80%. The surfactant used in the present invention formulation may be nonionic or anionic. The preferred surfactants are anionic.

The nonionic surfactants are members of the following classes of chemical compounds: alkyl ethoxylates, alkylaryl ethoxylates, ethylene oxide/propylene oxide diblock and triblock surfactants both linear and branched. Specific examples include: secondary alcohol ethoxylate (Tergitol™15-S-40), lauryl ethoxlate (12), octylphenol ethoxylate 7.5 (Triton™ X-114), nonylphenol ethoxylates, alkyl ethoxylates (Plurafac® Surfactants). In addition the nonionic surfactants that may be used in the present invention include Pluronic® Polyols, Pluronic® R Polyols, Tetronic® Polyols, Tetronic® R Polyols (available from BASF Corporation). These are block copolymer surfactants, both linear and branched, vary in molecular weight from about 1,000 to 27,000, have a propylene oxide block portion of molecular weight from about 800 to 5,000 and vary in ethylene oxide content from about 10% to 80%. They can be in liquid, paste or solid form depending upon the molecular weight and amount of propylene oxide and ethylene oxide contained in the block copolymer surfactant. Specific examples include: Pluronic® L31, L43, L61, L121, F87, F108, F127, Pluronic® R 10R8, 17R8, 25R5, 31 R4; Tetronic® 304, 901, 1102, 1304, 1502; Tetronic® R 50R8, 70R4, 90R8, 150R7.

The preferred surfactants are anionic. Examples include alkyl sulfates, alkylaromatic sulfonates, alkylaromatic sulfonic acids, aromatic sulfonates, aromatic sulfonic acids, alkyl ether phosphates, alkyl phosphates, alkylaromatic ether phosphates, alkyl ether phosphoric acids, alkyl phosphoric acids, and alkylaromatic ether phosphoric acids, alkyl sulfosuccinates, dialkyl sulfosuccinates, alkylethoxylated sulfosuccinates, dialkylethoxylated sulfosuccinates. Particularly preferred are dodecylbenzene sulfonate (linear or branched), dodecylbenzene sulfonic acid (linear or branched), xylene sulfonates, xylene sulfonic acid, cumene sulfonate, cumene sulfonic acid, paratoluene sulfonate, paratoluene sulfonic acid lauryl sulfosuccinate, dilauryl sulfosuccinate. The anionic form of these surfactants may have typical cationic counter ions such as sodium, lithium, potassium or ammonium. The most preferred surfactants are dodecylbenzene sulfonate (linear or branched), dodecylbenzene sulfonic acid (linear or branched). The examples provided above are not an exhaustive list of the surfactants that may be used in the present invention. One skilled in the art will recognize additional members and variations within the various categories listed above. Such additional compounds are considered to be within the scope of the present invention.

A single surfactant of the types listed above may be used in the formulations. Alternatively, formulations that include multiple surfactants are also considered as within the scope of the present invention.

The formulations of the present invention may also include a wetting agent at a concentration of from about 0.01% to 3%, by weight. For example, commercially available wetting agents, such as, fluorocarbon and silicone based wetting agents are particularly effective.

The formulations of the present invention include an acid or acid salt at a concentration of from about 0.01% to 20%, by weight. Various mono and polycarboxylic acids may be used. The acid may be an organic acid such as citric acid, benzoic, lactic, acetic, phthalic, oxalic, malonic, succinic, glutaric, adipic, pimelic, suberic, azelaic, sabacic, maleic, fumaric, itaconic, terphthalic, isophthalic, ethylenediaminetetraacetic, salicylic, trimellitic, hemimellitic. The formulation of the present invention may contain one acid or a combination of acids. A mono or multi salt of the acids, e.g., sodium, potassium, ammonium, lithium, and the like may be used. An inorganic acid such as phosphoric acid or sulfuric may also be used. Such acids and acid salts function as a buffer for the formulation. The preferred acids are citric, benzoic, lactic, acetic, boric, phthalic and the salts thereof.

The formulations of the present invention include a peroxide, preferably hydrogen peroxide, from about 0.01% to a concentration of about 55%. Various concentrations of starting hydrogen peroxide from various suppliers (FMC, Solvay, Degussa etc.) may be used to prepare the antimicrobial of the present invention—3%, 30%, 35%, 50% or 70%. Since hydrogen peroxide stability is particularly sensitive to the impurities found in water such as organic contamination or transition metals, such as iron, copper, magnesium, zinc, etc., that can catalyze decomposition of the formulations, purified water is used in the prior art in the formulation of this active ingredient in antimicrobial formulations. This adds to the cost and complexity of manufacture of formulations. However, in the present invention there is no need to use purified water in order to obtain stable formulations because of the stabilizing properties of the surfactant. Typical bottled or tap water from private or municipal sources is all that is required to provide stable formulations of the present invention. This greatly simplifies the preparation and manufacturing of the antimicrobial formulation of the present invention by eliminating equipment that was previously needed to purify water and reduces the manufacturing time cycle and manufacturing cost. Purified water may be used if especially long term stability, for example over 2 years, is required or other additives are included in the formulation which may shorten the stability of the antimicrobial formulation. In the present invention the hydrogen peroxide may be used alone or in combination with other peroxy compounds.

Preferred peroxides include: diacyl peroxides; dialkyl peroxides; diperoxyketals; hydroperoxides; ketone peroxides; peroxyesters; dicumyl peroxide; lauroyl peroxide; t-butylhydroperoxide; decanoyl peroxide; benzoyl peroxide; Succinic acid peroxide; 2,5-di(butylperoxy)-2,5-dimethyl hexane; t-butyl cumyl peroxide; bis(t-butylperoxy)diisopropylbenzene; di(t-amyl) peroxide; di(t-butyl) peroxide; 2,5-di(t-butylperoxy)-2,5-dimethyl-3 hexyne; 1,1 di(t-butylperoxy)-3,3,5-trimethylcyclohexane; 1,1 di(t-butylperoxy)cyclohexane; 1,1 di(t-amylperoxy)cyclohexane; n-butyl-4,4-di(t-butylperoxy)valerate; ethyl-3,3-di(t-amylperoxy)butanoate; ethyl-3,3-di(t-butylperoxy)butyrate; cumene hydroperoxide; t-butylhydroperoxide; methyl ethyl ketone peroxide; 2,4-pentanedione peroxide and hydrogen peroxide; 3-hydroxy-1,1-dimethylbutyl peroxyneofecanoate; alpha-cumyl peroxyneofecanoate; t-amyl peroxyneofecanoate; t-amyl peroxypivalate; t-butyl peroxypivalate; 2,5-di(2-ethylhexanoylperoxy)-2,5-dimethylhexane; t-amyl peroxy-2-ethylhexanoate; t-butyl peroxy-2-ethylhexanoate; t-amyl peracetate; t-butyl peracetate; t-butyl perbenzoate t-butyl peroxy-3,5,5-trimethylhexanoate.

The formulation includes a peracid. Preferred peracids include: peracetic acid; percitric acid; peroxymonosulfuric acid; perchloric acid; perpropronic acid; perbenzoic acid; and m-chloroperbenzoic acid.

The antimicrobial formulation of the present invention may contain a water soluble boron or copper compound. Preferred boron compounds include boric acid and sodium tetraborate decahydrate (borax). Preferred copper compounds include copper acetate, copper sulfate and the like.

Preferred persulfates include sodium persulfate; ammonium persulfate; potassium persulfate.

Preferred percarbonates and perborates include di(npropyl)peroxydicarbonate; di(sec-butyl)peroxydicarbonate; di(2-ethylhexyl)peroxydicarbonate; sodium carbonate peroxide; OO(t-amyl)-O-(2-ethylhexyl)monoperoxycarbonate; OO(t-amyl)-O-isopropylmonoperoxycarbonate; OO(t-butyl)-O-(2-ethylhexyl)monoperoxycarbonate; poly-t-butylperoxy carbonate; and sodium perborate.

The formulations of the present invention may include a wetting agent at a concentration of from about 0.01% to 3%, by weight. For example, commercially available wetting agents, such as but not limited to, fluorocarbon and silicone based wetting agents are particularly effective. Commercial examples include those from Dupont such as Zonyl® FSN-100, Zonyl® FSO-100 and Zonyl® FS-510.

The formulations of the present invention may include a thickener or rheology modifier. These include, but are not limited to, alkali soluble emulsions, hydrophobically modified alkali soluble emulsions, polyurethane associative thickeners and rheology modifiers, polyvinyl alcohol, and polysaccharides such as starch, modified starch, guar gums and xanthanes.

The formulations of the present invention may include an inorganic acid such as, but not limited to, sulfuric, phosphoric, phosphinic, sulfurous, perchloric, hydrochloric, hydrofluoric and nitric.

The formulations of the present invention may include a lithium, ammonium, potassium or sodium salt of a strong or weak acid. Examples include but are not limited to, sodium sulfate, potassium chloride, ammonium acetate, sodium phosphate, disodium phosphate.

The formulations of the present invention may include a filler or opacifiers such as, but not limited to, clay, diatomatious earth, silica, powdered sand, glass beads, synthetic particles or beads, hollow synthetic particles, hollow glass beads and powdered wood sawdust, or any combination of these or other fillers or opacifiers.

The formulations of the present invention may include a dye or colorant, such as but not limited to, food dyes, synthetic dyes, phosphorescent materials and dispersed dyes.

The formulations of the present invention may include a perfume or fragrance. Examples include essential oils such as but not limited to, rose, lavender, orange, pine, eucalyptus, menthol, thyme. Other fragrances, such as but not limited to, those consisting of combinations of esters, aldehydes, ketones, alcohols, carboxylic acids or aromatic which give a wide variety of scents can also be included.

The formulations of the present invention may include various types of corrosion inhibitors also incorporated into the anti-microbial formulation. U.S. Pat. No. 6,585,933, of Ehrhardt et al., the entirety of which is incorporated herein by reference, provides an extensive description of various corrosion inhibiting approaches. These corrosion inhibitors include inorganic and organic phosphorous based compounds, organic heterocyclic molecules, phenolics and other organic molecules containing a variety of functional groups, although any corrosion inhibitor may be used.

The formulations of the present invention may also include various types of additives to enhance the mildness to the skin. Examples include but are not limited to, humectants, moisturizers, aloe, lanolin, irritation mitigating surfactants and glycerin.

The formulations of the present invention include peracetic acid from about 0.01% to a concentration of about 30%. Various concentrations of starting peracetic acid (5%, 15%, 35%) from various suppliers may be used to prepare the antimicrobial of the present invention. Since peracetic acid stability is particularly sensitive to the impurities found in water such as organic contamination or transition metals, such as iron, copper, magnesium, zinc, etc., that can catalyze the decomposition, purified water is used in the prior art in the formulation of this active ingredient in antimicrobial formulations. However, in the present invention there is no need to use purified water in order to obtain stable formulations because of the stabilizing properties of the surfactant. Typical bottled or tap water from private or municipal sources is all that is required to provide stable formulations of the present invention. This greatly simplifies the preparation and manufacturing of the antimicrobial formulation of the present invention by eliminating equipment that was previously needed to purify water and reduces the manufacturing time cycle and manufacturing cost.

The formulations of the present invention include silver from about 0.00001% to a concentration of about 10%. The preferred sources of silver are water soluble silver salts such as silver acetate, silver nitrate, silver propionate and silver sulfate. The incorporation of silver has a special set of difficulties. Highly purified water is usually needed to insure the absence of halide ion, especially chloride ion. These halide ions rapidly and completely precipitate silver ion out of aqueous solution. Antimicrobial formulations where the silver is precipitated out is undesirable from both a functional and appearance standpoint. While in the prior art purified water is required in the present invention there is no need to use purified water in order to obtain efficacious antimicrobial formulations. The examples below demonstrate that the stabilizing surfactants used in the present invention surprisingly eliminate the precipitation of silver when typical tap water is used thereby eliminating the need to use purified water and simplifying the manufacturing process. In addition to silver salts or compounds, the silver can be introduced into these antimicrobial formulations by electrolytic methods such as having one of the electrodes composed of silver and passing a current through the aqueous solution. Examples are illustrated below.

### SILVER SOLUBILITY STABILIZATION EXAMPLES

### Example 1

To 10 g of tap water (Newark, N.J. municipal water source) are added 2 drops of 1% silver nitrate solution, approximately 60 ppm silver nitrate in total. Rapidly a white/hazy mixture forms indicating the silver has precipitated out.

### Example 2

To 10 g of tap water are added 4 drops of 1% silver nitrate solution, approximately 120 ppm silver nitrate in total. Rapidly a white/hazy mixture forms indicating the silver has precipitated out.

### Example 3

To 10 g of tap water containing 0.2 g citric acid are added 2 drops of 1% silver nitrate solution, approximately 60 ppm silver nitrate in total. Rapidly a white/hazy mixture forms indicating the silver has precipitated out.

### Example 4

To 10 g of tap water containing 0.2 g citric acid are added 4 drops of 1% silver nitrate solution, approximately 120 ppm silver nitrate in total. Rapidly a white/hazy mixture forms indicating the silver has precipitated out.

### Example 5

To 10 g of tap water containing 0.2 g dodecylbenzene sulfonic acid (anionic surfactant available as BioSoft S101 from Stepan Company) are added 2 drops of 1% silver nitrate solution, approximately 60 ppm silver nitrate in total. The solution remains clear even after 5 minutes of mixing indicating the silver has not precipitated out. This surfactant keeps the silver in solution. No precipitation is observed after 2 weeks.

### Example 6

To 10 g of tap water containing 0.2 g dodecylbenzene sulfonic acid (anionic surfactant available as BioSoft S101 from Stepan Company) are added 4 drops of 1% silver nitrate solution, approximately 120 ppm silver nitrate in total. The solution remains clear even after 5 minutes of mixing indicating the silver has not precipitated out. This surfactant keeps the silver in solution.

### Example 7

To 10 g of tap water containing 0.2 g dodecylbenzene sulfonic acid (anionic surfactant available as BioSoft S101 from Stepan Company) are added 20 drops of 1% silver nitrate solution, approximately 600 ppm silver nitrate in total. The solution remains clear even after 5 minutes of mixing indicating the silver has not precipitated out. This surfactant keeps the silver in solution.

### Example 8

To 10 g of tap water containing 0.2 g of Pluronic L-31 (nonionic surfactant available from BASF) are added 2 drops of 1% silver nitrate solution, approximately 60 ppm silver nitrate in total. Rapidly a white/hazy mixture forms indicating the silver has precipitated out.

### Example 9

To 10 g of tap water containing 0.2 g of Pluronic L-31 (nonionic surfactant available from BASF) are added 4 drops of 1% silver nitrate solution, approximately 120 ppm silver nitrate in total. Rapidly a white/hazy mixture forms indicating the silver has precipitated out.

### Example 10

To 10 g of tap water containing 0.2 g of Pluronic L-31 (nonionic surfactant available from BASF) are added 20 drops of 1% silver nitrate solution, approximately 600 ppm silver nitrate in total. Rapidly a white/hazy mixture forms indicating the silver has precipitated out.

### Example 11

To 10 g of tap water containing 0.2 g of Pluronic F-38 (nonionic surfactant available from BASF) are added 2 drops of 1% silver nitrate solution, approximately 60 ppm silver nitrate in total. Rapidly a white/hazy mixture forms indicating the silver has precipitated out.

### Example 12

To 10 g of tap water containing 0.2 g of Pluronic F-38 (nonionic surfactant available from BASF) are added 4 drops of 1% silver nitrate solution, approximately 120 ppm silver nitrate in total. Rapidly a white/hazy mixture forms indicating the silver has precipitated out.

### Example 13

To 10 g of tap water containing 0.2 g of Pluronic F-38 (nonionic surfactant available from BASF) are added 20 drops of 1% silver nitrate solution, approximately 600 ppm silver nitrate in total. Rapidly a white/hazy mixture forms indicating the silver has precipitated out.

### Example 14

To 10 g tap water are added 2 drops of 1% silver nitrate solution, approximately 60 ppm silver nitrate in total. Rapidly a white/hazy mixture forms indicating the silver has precipitated out. Addition of 0.2 g dodecylbenzene sulfonic acid (anionic surfactant available as BioSoft S101 from Stepan Company) still results in a white/hazy mixture showing that the dodecylbenzene sulfonic acid (available as BioSoft S100 from Stepan Company) must be in the water before the silver nitrate is added in order to prevent silver precipitation.

### Example 15

To 10 g tap water are added 4 drops of 1% silver nitrate solution, approximately 120 ppm silver nitrate in total. Rapidly a white/hazy mixture forms indicating the silver has precipitated out. Addition of 0.2 g dodecylbenzene sulfonic acid (available as BioSoft S101 from Stepan Company) still results in a white/hazy mixture showing that the dodecylbenzene sulfonic acid (available as BioSoft S101 from Stepan Company) must be in the water before the silver nitrate is added in order to prevent silver precipitation.

The examples above clearly demonstrate the unexpected stabilizing ability of the dodecylbenzene sulfonic acid surfactant (Biosoft S101) at preventing the precipitation of silver from ordinary tap water. The surfactant (dodecylbenzene sulfonic acid) should be present in the water before the addition of the silver in order to keep the silver in solution and to prevent the silver from precipitating out of the formulation.

### Antimicrobial General Formulation

The antimicrobial formulation of the present invention may contain a water soluble solvent from about 0.01% to a concentration of about 20%. Preferred solvents include: alcohols ranging in carbon content from C1 to C8. Methanol, ethanol, 1-propanol, 2-propanol, 1-butanol, 2-butanol, tert-butanol, benzyl alcohol, butylcellusolve are the preferred solvents.

The antimicrobial formulation of the present invention may contain a peroxy stabilizer such as sodium pyrophosphate, organophosphates, acetanilide, phosphinic acid derivatives or sodium stannate and the like. The antimicrobial formulations of the present invention have excellent stability even in the absence of these types of peroxy stabilizers. The formulations of the present invention containing the various components indicated herein above may be in the form of a liquid, viscous liquid, liquid, e.g., a liquid soap or foam soap, a pasty mixture, e.g., a heavy-duty soap used by mechanics, or a semi-solid or solid, e.g., a bar of soap. This depends on the solids content of the formulation and the present invention contemplates all of such forms. The formulation can be made ready to use or at a high concentration where it can be dosed into the application it is being used for, for example water treatment. However, the form of the inventive composition does not affect its antimicrobial properties. The inventive formulation, in such forms, may have components in the following amounts (All percent weights herein are based on the total weight of the formulation):

| Component | | | |
|---|---|---|---|
| (weight % of | | | Most Preferred |
| ingredient) | Range | Preferred range | Range |
| Surfactant | 0.01-80 | 0.05-50 | 0.1-20 |
| Acid or acid salt | 0.01-20 | 0.05-15 | 0.1-10 |
| Peroxide | 0.1-55 | 0.4-40 | 0.6-35 |
| Peracid | 0.05-30 | 0.15-20 | 0.3-14 |
| Silver as silver | 0.001-10 | 0.003-6 | 0.1-3 |
| nitrate | | | |
| Water soluble | 0-20 | 0-15 | 0-10 |
| solvent | | | |
| Boron or copper | 0-10 | 0-7 | 0-5 |
| salt or compound | | | |
| Remainder water | | | |
| pH range | Less than about 6 | Less than about 4 | Less than about |
| | | | 2 |

The table lists the essential ingredients and water; other ingredients may be added to the formulation, such as but not limited to, wetting agents, peroxy stabilizers, thickeners or rheology modifiers, metal salts of weak acids, fillers, opacifiers, humectants, gels, odor adsorbing agents, cyclodextrins, starches, modified starches, guar gums, dyes or colorants, perfume or fragrances, corrosion inhibitors, additives to enhance mildness to skin, or any other additives which improve the product in any way and/or give it enhanced properties.

The pH of the antimicrobial formulation of the present invention is less than 7 and depends on the weight percentages of the various components. Preferably the pH of the antimicrobial formulation of the present invention is less than 4, most preferably the pH of the antimicrobial formulation of the present invention is less than 2. Prior art, U.S. Pat. No. 7,056,536, teaches that peracetic acid antimicrobials are corrosive at acidic pH ranges, especially less than a pH of 4. This is another distinguishing characteristic of the antimicrobial formulations of the present invention since they are not corrosive at acidic pH, even very acidic pH values of less than about 2. The data in the tables below include the concentrations of each component in each formulation. In the case of peracetic acid, this component may reequilibrate to a slightly different level.

An important distinguishing feature of the present invention and the prior art is that the antimicrobial formulations of the present invention do not contain any corrosion inhibitors that are commonly added to prevent corrosion to ferrous metals and yellow metals such as copper, brass and bronze. Example of these prior art corrosion inhibitors are summarized in U.S. Pat. No. 6,585,933 of Ehrhardt et al., the entirety is incorporated herein by reference, and include certain inorganic compounds and organic type compounds containing, nitrogen, sulfur, oxygen, and/or phosphorus. Examples include molybdates, chromates, tungstates, tetaazoles, triazoles, amines, imidazolines, aminophosphates and aminophosphatetetraazolium. Surprisingly in the present invention the proper incorporation and weight ratio of the formulation components provides the noncorrosive feature of these antimicrobial formulations. The noncorrosive feature of the present invention is so strong that it can be regarded as a corrosion preventive formulation. This is an unexpected feature in view of the acidic pH of the antimicrobial formulations of the present invention. The examples below exemplify these features.

### Corrosion Tests

The corrosion or oxidation tests were first conducted on iron and a particularly challenging corrosion test was performed as follows at room temperature: a small piece (about ½ inch×½ inch×¼ inch) of “#0000” finishing grade steel wool available at Home Depot, Lowe's Building Centers or any local hardware store is placed in a 10 ounce crystal clear plastic glass, manufactured by Waddington North America Inc. and available at Costco. To the glass with the piece of “0000” steel wool are added about 15 milliliters of the anti-microbial formulation to be tested. The 15 ml completely covers the piece of steel wool. All anti-microbial formulations of the present invention are initially clear and colorless—unless a water insoluble surfactant is used which results in a hazy mixture or emulsion—and are also stable since no degassing or pressure build up is observed in the bottles used for storage. The various formulations tested ranged in pH from about 0.5 to about 8. The glass and contents are covered with a clear plastic food wrap to prevent the liquid formulation from evaporating. No agitation of the samples are required, this is a static test. The contents of the glass are visually inspected at the time intervals indicated in the tables. Both the clarity and color of the solution (sol) along with the extent of corrosion or rusting (rust) of the steel wool are noted. A comment of “rust” indicates that the steel wool was significantly, at least half, covered with oxidized material. A comment of “total rust” indicates that the steel wool is totally covered with oxidized material—extremely severe corrosion, a comment of “dissolved” indicates that the severity of the corrosion is so great that the steel wool is totally oxidized and disappears; monitoring of the sample at this point stops. A comment of “clear, no rust” indicates that the anti-microbial formulation is not corrosive to ferrous metals. This corrosion test involving a piece of “#0000” finishing grade steel wool is particularly difficult to pass because of the very large surface to volume ratio of this steel wool and of the ease at which uncoated, unprotected, unalloyed to resist corrosion iron will corrode in the presence of oxidizing agents.

Formulations that are corrosive usually show signs of corrosion in 19 hours or less and this degree of corrosiveness is unacceptable for anti-microbial formulations since articles made of ferrous metals are very common and would rather quickly be rendered useless. Passing this test after 2 weeks of contact is very difficult. Those formulations that pass after 2 weeks are especially noncorrosive to ferrous metals. Passing the ferrous metal corrosion or oxidation test is important since iron is a significant component to many surfaces, article and items encountered in the household, commercial, personal care, food processing and health care areas that require treatment with antimicrobials. Antimicrobial formulations that corrode ferrous metals are inferior to antimicrobial formulations of the present invention. To be a viable anti-microbial formulation, it should not cause any corrosion on common iron in less than a 2 week period at room temperature. The tables that follow use the same corrosion test protocol.

The results in Table 1 below indicate that commercially available antimicrobial formulations based on the prior art are corrosive to ferrous metals. In addition in the presence of ordinary tap water the steel wool will corrode.

TABLE 1
Ferrous Metal Corrosion/Oxidation Study of Commercial Antimicrobials Based
Upon Prior Art

| | | Corrosion | Corrosion | Corrosion | Corrosion | Corrosion |
|---|---|---|---|---|---|---|
| | | after 2 | after 19 | after 43 | after 67 | after 2 |
| Example # | Antimicrobial | hours | hours | hours | hours | weeks |
| 16 | 2% aqueous | Significant | dissolved | — | — | — |
| | Peracetic acid | rust, | | | | |
| | | brown | | | | |
| 17 | 3% aqueous | Light | Brown | Brown | Brown | Brown |
| | Hydrogen Peroxide | brown | significant | significant | significant | significant |
| | | | rust | rust | rust | rust |
| 18 | Oxivir ™ | clear | Slight | yellow | yellow | yellow and |
| | | | yellow | and rust | and rust | rust |
| 19 | Scrubbing | clear | Slight | yellow | yellow | yellow and |
| | Bubbles ® Automatic | | yellow | and rust | and rust | rust |
| | Shower Cleaner | | | | | |
| 20 | Germ Control 24 | clear | Yellow | dissolved | — | — |
| | Odoban ® | | | | | |
| 21 | Clorox ® Regular | clear | Tan | Dissolved | — | — |
| | Bleach | | | | | |
| 22 | Dial Complete ® | Clear | tan | Light | Light | dissolved |
| | | peach | | brown, | brown, | |
| | | | | rust | rust | |
| 23 | Tap water | clear | clear | Tan, rust | Brown, | Brown, significant |
| | | | | | rust | rust |

The reagents and solutions used for the experiments in the table above and the vendors from which they were obtained are: 2% aqueous peracetic acid prepared from 35% peracetic acid available from FMC Corporation; 3% hydrogen peroxide from Cumberland Swan, Smyrna, Tenn.; Oxivir™—hydrogen peroxide based antimicrobial available from S. C. Johnson; Scrubbing Bubbles available from S. C. Johnson; Germ Control 24—silver based antimicrobial and available from Pure Bioscience; Clorox Bleach—hypochlorite based available from The Clorox Corporation; Dial Complete—triclosan based antimicrobial available from the Dial Corporation.

The results in Table 1 show that commercially available antimicrobial formulations based upon the prior art are corrosive to and oxidize ferrous metals. Even the supposedly mild to the skin Dial Complete is corrosive to ferrous metals. In addition tap water also corrodes iron. As we will show below the antimicrobial formulations of the present invention do not corrode iron and protect iron, “#0000” steel wool, from corrosion.

Table 2 shows the noncorrosive to ferrous metals characteristics of the antimicrobial formulations of the present invention. BS101 refers to Biosoft S101 which is dodecylbenzene sulfonic acid available from the Stepan Company.

TABLE 2
Ferrous Metal Corrosion/Oxidation Test Results for Antimicrobial Formulations of
the Present Invention

| | | | | | | | Corrosion | |
|---|---|---|---|---|---|---|---|---|
| | Weight % | Weight % | Weight % | Weight % | Ppm | Corrosion | after | Corrosion |
| | Surfactant | citric | Hydrogen | Peracetic | Silver | after | 19 | after 2 |
| Example # | and Type | acid | peroxide | acid | nitrate | 2 hours | hours | weeks |
| 24 | 0.1%, | 2.1 | 2.0 | 0.6 | 1000 ppm | Clear, | Clear, | Clear, |
| | BS101 | | | | | no rust | no rust | no |
| | | | | | | | | rust |
| 25 | 0.1%, | 2.1 | 2.0 | 0.6 | 1000 ppm | Clear, | Clear, | Clear, |
| | BS101 | | | | | no rust | no rust | no |
| | | | | | | | | rust |
| 26 | 0.1%, | 1.8 | 2.0 | 0.6 | 1000 ppm | Clear, | Clear, | Clear, |
| | BS101 | | | | | no rust | no rust | no |
| | | | | | | | | rust |
| 27 | 0.1%, | 2.1 | 2.0 | 0.6 | 1000 ppm | Clear, | Clear, | Clear, |
| | BS101 | | | | | no rust | no rust | no |
| | | | | | | | | rust |
| 28 | 2.0% | 0.2 | 2.0 | 0.6 | 1000 ppm | Clear, | Clear, | Clear, |
| | BS101 | | | | | no rust | no rust | no |
| | | | | | | | | rust |
| 29 | 2.0% | 2.0 | 2.0 | 0.6 | 1000 ppm | Clear, | Clear, | Clear, |
| | BS101 | | | | | no rust | no rust | no |
| | | | | | | | | rust |
| 30 | 2.0% | 0.2 | 2.0 | 0.6 | 1000 ppm | Clear, | Clear, | Clear, |
| | BS101 | | | | | no rust | no rust | no |
| | | | | | | | | rust |
| 31 | 2.0% | 0.2 | 2.0 | 0.6 | 1000 ppm | Clear, | Clear, | Clear, |
| | BS101 | | | | | no rust | no rust | no |
| | | | | | | | | rust |
| 32 | 2.0% | 0.2 | 2.0 | 0.6 | 1000 ppm | Clear, | Clear, | Clear, |
| | BS101 | | | | | no rust | no rust | no |
| | | | | | | | | rust |
| 33 | 2.0% | 0.2 | 2.0 | 0.6 | 1000 ppm | Clear, | Clear, | Clear, |
| | BS101 | | | | | no rust | no rust | no |
| | | | | | | | | rust |
| 34 | 2.0% | 0.1 | 2.0 | 0.6 | 1000 ppm | Clear, | Clear, | Clear, |
| | BS101 | | | | | no rust | no rust | no |
| | | | | | | | | rust |
| 35 | 3.0% | 0.1 | 2.0 | 0.6 | 1000 ppm | Clear, | Clear, | Clear, |
| | BS101 | | | | | no rust | no rust | no |
| | | | | | | | | rust |
| 36 | 1.0% | 0.1 | 2.0 | 0.6 | 1000 ppm | Clear, | Clear, | Clear, |
| | BS101 | | | | | no rust | no rust | no |
| | | | | | | | | rust |
| 37 | 0.5% | 0.1 | 2.0 | 0.6 | 1000 ppm | Clear, | Clear, | Clear, |
| | BS101 | | | | | no rust | no rust | no |
| | | | | | | | | rust |
| 38 | 1.5% | 0.1 | 2.0 | 0.6 | 1000 ppm | Clear, | Clear, | Clear, |
| | BS101 | | | | | no rust | no rust | no |
| | | | | | | | | rust |
| 39 | 5.0% | 0.1 | 2.0 | 0.6 | 1000 ppm | Clear, | Clear, | Clear, |
| | BS101 | | | | | no rust | no rust | no |
| | | | | | | | | rust |
| 40 | 2.0% | 0.1 | 2.0 | 0.6 | 1000 ppm | Clear, | Clear, | Clear, |
| | BS101 | | | | | no rust | no rust | no |
| | | | | | | | | rust |
| 41 | 2.0% | 0.0 | 2.0 | 0.6 | 1000 ppm | Clear, | Clear, | Clear, |
| | BS101 | | | | | no rust | no rust | no |
| | | | | | | | | rust |
| 42 | 3.0% | 0.0 | 2.0 | 0.6 | 1000 ppm | Clear, | Clear, | Clear, |
| | BS101 | | | | | no rust | no rust | no |
| | | | | | | | | rust |

The second corrosion or oxidation test was conducted on copper and a particularly difficult to pass corrosion test was performed as follows at room temperature. A piece of number 12 electrical wire was freshly stripped of its insulation and cut into about one inch lengths. The freshly stripped copper wire has a very bright shine and luster. This copper electrical wire is available at Home Depot, Lowe's Building Centers or any local hardware store. The one inch long piece of copper wire was placed in a 10 ounce crystal clear plastic glass, manufactured by Waddington North America Inc. and available at Costco.

Approximately 15 milliliters (mL) of the anti-microbial formulation to be tested were added to the glass with the piece of bright copper wire. The 15 ml completely covered the piece of copper wire. All antimicrobial formulations of the present invention are initially clear and colorless—unless a water insoluble surfactant is used or some silver has precipitated out which results in a hazy mixture or emulsion—and are also stable as evidenced by the fact that no degassing or pressure build up is observed in the bottles used for storage. The various formulations of the present invention tested ranged in pH from about 0.5 to about 8.

The glass and contents were covered with a clear plastic food wrap to prevent the liquid formulation from evaporating. No agitation of the samples was required, this was a static test.

The contents of the glass were visually inspected at the time intervals indicated in the tables. Both the clarity and color of the solution (sol) along with the extent of corrosion or discoloration of the initially bright copper were noted. A comment of “discolored” indicates that the copper was completely covered with oxidized material, meaning severe corrosion had occurred. A comment of “off color” indicates that the copper had lost some of its brightness and corrosion was about to begin. A comment of “clear, no color” indicates that the anti-microbial formulation was not corrosive to copper. A comment of slight blue or green indicates copper salts were in the antimicrobial solution and indicates corrosion was about to begin. Additional specific comments are also made in the following tables.

This corrosion test involving a piece bright copper wire is particularly difficult to pass because of the ease at which uncoated, unprotected, unalloyed to resist corrosion copper will lose its initial brightness. Loss of the initial brightness of the copper wire indicates that the corrosion process has begun, even if only slightly. Formulations that are corrosive usually show signs of corrosion in 2 hours or less. Passing this test after 5 hours of contact is very difficult and represents an extremely long contact time. Those formulations that pass after 16 hours are especially noncorrosive to copper.

Antimicrobial formulations that corrode copper are inferior to antimicrobial formulations of the present invention. To be a viable anti-microbial formulation, it should not cause any corrosion on copper (loss of brightness/brilliance) in less than a 5 hour period at room temperature. Passing the copper corrosion or oxidation test is important since copper is a significant component to many surfaces, articles and items encountered in the household, commercial, personal care, food processing and health care areas that require treatment with antimicrobials.

The antimicrobial formulations of the present invention pass both the iron and copper corrosion test. Commercial antimicrobial formulations based upon the prior art corrode iron, copper, or both. Corrosion of either of these metals is unacceptable because of the wide spread use of ferrous metals and copper in items, articles and surfaces that are treated with antimicrobial formulations. This type of corrosion will ruin these items, articles and surfaces that are treated with antimicrobial formulations resulting in costly repair or replacement. In the case of medical applications, corrosion may lead to infection of a patient if an operating tool is affected. The corrosion test protocol described above was used for the examples in Tables 3-8.

TABLE 3
Copper Corrosion/Oxidation Test Results for Antimicrobial Formulations Based
Upon The Prior Art

| | | | | Corrosion | Corrosion |
|---|---|---|---|---|---|
| | | Corrosion | Corrosion | after 5 | after 16 |
| Example # | Antimicrobial | after 1 hour | after 2 hours | hours | hours |
| 43 | 2% Peracetic | Generation | Generation | Generation | Generation |
| | Acid | of bubbles | of bubbles | of bubbles | of bubbles |
| | | on surface | on surface | on surface | on surface |
| | | of copper, | of copper, | of copper, | of copper, |
| | | discolored | very | very | very |
| | | | discolored | discolored | discolored |
| | | | | and rough | and rough |
| | | | | surface | surface |
| 44 | 3% hydrogen | Generation | Large | Large | Large |
| | peroxide | of bubbles | bubbles on | bubbles on | bubbles on |
| | | on surface | surface | surface, | surface, |
| | | of copper | | slight off | slight off |
| | | | | color | color |
| 45 | Oxivir ™ | Slight | Yellow | Green, off | Dark green |
| | | yellow | green, slight | color | brown, off |
| | | | off color | | color |
| 46 | Germ Control 24 | clear | clear | clear | Slight green |
| 47 | Clorox ® | clear | Light blue | Thick blue | Thick blue |
| | Regular Bleach | | | salt on | salt on |
| | | | | surface of | surface of |
| | | | | copper | copper |

The results in Table 3 indicate that the antimicrobials based upon the prior art are corrosive to and oxidize copper and are inferior to the present invention.

Table 4 provides comparative examples of antimicrobials based upon continuation in part of U.S. Ser. No. 11/746,975 filed on May 10, 2007, which is incorporated herein by reference. These formulations are also corrosive to and oxidize copper.

TABLE 4
Copper Corrosion/Oxidation Test Results for Antimicrobial Formulations Based
Upon U.S. Ser. No. 11/746,975.
No Silver in These Formulations - Comparative Examples

| | | | | | | | | CorroSion |
|---|---|---|---|---|---|---|---|---|
| | Weight % | Weight % | Weight % | Weight % | CorroSion | Corro- | CorroSion | after |
| | BioSoft | citric | Hydrogen | Peracetic | after 1 | after 2 | after 5 | 16 |
| Example # | S101 | acid | peroxide | acid | hour | hours | hours | weeks |
| 48 | 0.1 | 1.9 | 2.0 | 0.6 | Bubbles | Bubbles | Bubbles | Bubbles |
| | | | | | on | on | on | on |
| | | | | | surface | surface | surface | surface |
| | | | | | of | of | of | of |
| | | | | | copper, | copper, | copper, | copper, |
| | | | | | light | light | light | light |
| | | | | | green, | green, | green, | green, |
| | | | | | discolor | discolor | discolor | discolor |
| 49 | 0.1 | 3.0 | 3.0 | 3.0 | Bubbles | Bubbles | Bubbles | Bubbles |
| | | | | | on | on | surface | on |
| | | | | | surface | surface | of | surface |
| | | | | | of | of | copper, | of |
| | | | | | copper, | copper, | light | copper, |
| | | | | | light | light | green, | light |
| | | | | | green, | green, | discolor | green, |
| | | | | | discolor | discolor | | discolor |
| 50 | 0.1 | 2.1 | 1.9 | 0.6 | Bubbles | Bubbles | Bubbles | Bubbles |
| | | | | | on | on | on | on |
| | | | | | surface | surface | surface | surface |
| | | | | | of | of | of | of |
| | | | | | copper, | copper, | copper, | copper, |
| | | | | | light | light | light | light |
| | | | | | green, | green, | green, | green, |
| | | | | | discolor | discolor | discolor | discolor |
| 51 | 0.1 | 1.8 | 1.9 | 0.6 | Bubbles | Bubbles | Bubbles | Bubbles |
| | | | | | on | on | on | on |
| | | | | | surface | surface | surface | surface |
| | | | | | of | of | of | of |
| | | | | | copper, | copper, | copper, | copper, |
| | | | | | light | light | light | light |
| | | | | | green, | green, | green, | green, |
| | | | | | discolor | discolor | discolor | discolor |
| 52 | 2.0 | 0.2 | 2.0 | 0.6 | light | light | light | light |
| | | | | | green, | green, | green, | green, |
| | | | | | off color | off color | off color | off |
| | | | | | | | | color |
| 53 | 2.0 | 2.0 | 2.0 | 0.6 | light | green, | green, | green, |
| | | | | | green, | off color | off color | off |
| | | | | | off color | | | color |
| 54 | 2.0 | 2.0 | 2.0 | 0.6 | light | green, | green, | green, |
| | | | | | green, | off color | off color | discolor, |
| | | | | | off color | | | rough |
| | | | | | | | | surface |
| 55 | 2.0 | 0.2 | 2.0 | 0.6 | Bubbles | Bubbles | Bubbles | Green, |
| | | | | | On | On | On | discolor |
| | | | | | Copper | Copper | Copper | |
| | | | | | surface, | surface, | surface, | |
| | | | | | off color | off color, | discolor | |
| | | | | | | some | | |
| | | | | | | green | | |

The results in Table 4 indicate that these antimicrobials are corrosive to and oxidize copper and are inferior to the present invention and are similar to antimicrobials based upon the prior art which are also corrosive to and oxidize copper and are inferior to the present invention. The presence of bubbles on the copper surface indicates a reaction of the copper and peroxy antimicrobial is taking place.

The results in Table 5 show a novel and unexpected result in that in the present invention we have surprisingly found that the addition of silver to peroxy containing antimicrobials results in significantly reduced corrosion to copper. In addition we have found that changing the ratio of the Biosoft S101 surfactant (dodecylbenzene sulfonic acid) to organic acid, in this case citric acid, in combination with the addition of silver again surprisingly results in peroxy/silver antimicrobials that are not corrosive to copper. Increasing the weight ratio of the Biosoft S101 surfactant (dodecylbenzene sulfonic acid) to citric acid from about 0.05 to about 1 improves resistance to copper corrosion. A further increase of the weight ratio of the Biosoft S101 surfactant (dodecylbenzene sulfonic acid) to the citric acid to about 10 or higher provides an additional improvement to the copper corrosion resistance results.

TABLE 5
Copper Corrosion/Oxidation Test Results for Antimicrobial Formulations
of the Present Invention

| | | | | | | | | | Corrosion |
|---|---|---|---|---|---|---|---|---|---|
| | Weight % | Weight % | Weight % | Weight % | ppm | Corrosion | Corrosion | Corrosion | after |
| | BioSoft | citric | Hydrogen | Peracetic | silver | after 1 | after 2 | after 5 | 16 |
| Example # | S101 | acid | peroxide | acid | nitrate | hour | hours | hours | hours |
| 56 | 0.1 | 2.1 | 2.0 | 0.6 | 1000 | Clear, | Clear, | Clear, | Clear, |
| | | | | | | off | off | off | off |
| | | | | | | color | color, | color, | color, |
| | | | | | | | very | very | very |
| | | | | | | | light | light | light |
| | | | | | | | blue | blue | blue |
| 57 | 0.1 | 2.1 | 2.0 | 0.6 | 1000 | Clear, | Clear, | Clear, | Clear, |
| | | | | | | off | off | off | off |
| | | | | | | color | color, | color, | color, |
| | | | | | | | very | very | very |
| | | | | | | | light | light | light |
| | | | | | | | blue | blue | blue |
| 58 | 0.1 | 1.8 | 2.1 | 0.6 | 1000 | Clear, | Clear, | Clear, | Clear, |
| | | | | | | off | off | off | off |
| | | | | | | color | color, | color, | color, |
| | | | | | | | very | very | very |
| | | | | | | | light | light | light |
| | | | | | | | blue | blue | blue |
| 59 | 2.0 | 2.0 | 2.0 | 0.6 | 1000 | Clear, | Clear, | Clear, | Clear, |
| | | | | | | light | light | light | light |
| | | | | | | green | green | green | green |
| 60 | 2.0 | 0.2 | 2.0 | 0.6 | 1000 | Clear | Clear | Clear | Clear |
| 61 | 2.0 | 0.2 | 2.0 | 0.6 | 1000 | Clear | Clear | Clear | Clear, |
| | | | | | | | | | very |
| | | | | | | | | | slight |
| | | | | | | | | | off |
| | | | | | | | | | color |
| 62 | 2.0 | 0.2 | 2.0 | 0.6 | 1000 | Clear | Clear | Clear | Clear, |
| | | | | | | | | | very |
| | | | | | | | | | slight |
| | | | | | | | | | off |
| | | | | | | | | | color |
| 63 | 2.0 | 0.2 | 2.0 | 0.6 | 1000 | Clear | Clear | Clear, | Clear, |
| | | | | | | | | light | off |
| | | | | | | | | green | color, |
| | | | | | | | | | light |
| | | | | | | | | | green |
| 64 | 2.0 | 0.2 | 2.0 | 0.6 | 1000 | Clear | Clear | Clear | Clear |
| 65 | 0.5 | 0.1 | 2.0 | 0.6 | 1000 | Clear | Clear | Clear | Clear, |
| | | | | | | | | | very |
| | | | | | | | | | slight |
| | | | | | | | | | off |
| | | | | | | | | | color |
| 66 | 1.0 | 0.1 | 2.0 | 0.6 | 1000 | Clear | Clear | Clear | Clear |
| 67 | 1.5 | 0.1 | 2.0 | 0.6 | 1000 | Clear | Clear | Clear | Clear |
| 68 | 2.0 | 0.1 | 2.0 | 0.6 | 1000 | Clear | Clear | Clear | Clear |
| 69 | 2.0 | 0.1 | 2.0 | 0.6 | 1000 | Clear | Clear | Clear | Clear, |
| | | | | | | | | | very |
| | | | | | | | | | slight |
| | | | | | | | | | off |
| | | | | | | | | | color |
| 70 | 3.0 | 0.1 | 2.0 | 0.6 | 1000 | Clear | Clear | Clear | Clear |
| 71 | 5.0 | 0.1 | 2.0 | 0.6 | 1000 | Clear | Clear | Clear | Clear, |
| | | | | | | | | | very |
| | | | | | | | | | slight |
| | | | | | | | | | off |
| | | | | | | | | | color |
| 72 | 2.0 | 0 | 2.0 | 0.6 | 1000 | Clear | Clear | Clear | Clear |
| 73 | 0.1 | 2.1 | 2.0 | 0.6 | 1000 | Clear | Clear | Clear, | Clear, |
| | | | | | | | | very | very |
| | | | | | | | | slight | slight |
| | | | | | | | | off | off |
| | | | | | | | | color | color, |
| | | | | | | | | | very |
| | | | | | | | | | slight |
| | | | | | | | | | blue |
| 74 | 3.0 | 0 | 2.0 | 0.6 | 1000 | Clear | Clear | Clear | Clear |

The results in Table 5 show that the peroxy-silver antimicrobial formulations of the present invention are not corrosive to and do not oxidize copper. As the Biosoft S101 surfactant to organic acid, in this case citric acid, ratio increases an improvement in the resistance to copper corrosion/oxidation is observed.

The next corrosion test was conducted on brass and a particularly difficult to pass corrosion test was performed as follows at room temperature. Two #8×¾ inch brass flat head Phillips screws (distributed by Crown Bolt Inc. available at Home Depot; other comparable brass screws can be used which are also available at Lowe's Building Centers or any local hardware store) were placed in a 10 ounce crystal clear plastic glass, manufactured by Waddington North America Inc. and available at Costco. To the glass with the two brass screws were added about 15 milliliters of the anti-microbial formulation to be tested. The 15 ml completely covered the brass screws.

All antimicrobial formulations of the present invention are initially clear and colorless—unless a water insoluble surfactant is used or some silver has precipitated out which results in a hazy mixture or emulsion—and are also stable since no degassing or pressure build up is observed in the bottles used for storage. The various formulations of the present invention tested ranged in pH from about 0.5 to about 8. The glass and contents were covered with a clear plastic food wrap to prevent the liquid formulation from evaporating: No agitation of the samples was required, this was a static test. The contents of the glass were visually inspected at the time intervals indicated in the tables. Both the clarity and color of the solution (sol) along with the extent of corrosion or discoloration of the initially bright brass are noted.

A comment of “discolored” indicates that the brass was completely covered with oxidized material, meaning severe corrosion occurred. A comment of “off color” indicates that the brass had lost some of its brightness and corrosion was about to begin. A comment of “clear, no color” indicates that the anti-microbial formulation was not corrosive to brass. A comment of slight blue or green indicates copper salts had been formed in the antimicrobial solution and indicates corrosion was about to accelerate.

Formulations that are corrosive usually show signs of corrosion in 2 hours or less. Passing this test after 5 hours of contact is very difficult and represents an extremely long contact time. Those formulations that pass after 16 hours are especially noncorrosive to brass. Antimicrobial formulations that corrode brass are inferior to antimicrobial formulations of the present invention. To be a viable anti-microbial formulation, it should not cause any corrosion to brass in less than a 5 hour period at room temperature. The antimicrobial formulations of the present invention pass the iron and the copper and the brass corrosion tests. Commercial antimicrobial formulations based upon the prior art corrode iron, copper or brass, two of the metals, or all three of the metals. Corrosion of any of these three metals is unacceptable because of the wide spread use of ferrous metals and copper and brass in items, articles and surfaces that are treated with antimicrobial formulations. This type of corrosion will ruin these items, articles and surfaces that are treated with antimicrobial formulations resulting in costly repair or replacement. The other tables that follow use the same corrosion test protocol.

Table 6 below shows that the antimicrobial formulations of the present invention do not corrode or oxidize brass.

TABLE 6
Brass Corrosion/Oxidation Test Results for Antimicrobial Formulations of the
Present Invention

| | Weight % | Weight | Weight % | Weight % | ppm | Corrosion | | | |
|---|---|---|---|---|---|---|---|---|---|
| | BioSoft | % citric | Hydrogen | Peracetic | silver | after 1 | after 2 | after 5 | after 16 |
| Example # | S101 | acid | peroxide | acid | nitrate | hour | hours | hours | hours |
| 75 | 2.0 | 0.1 | 2.0 | 0.6 | 1000 | Clear, no | Clear, no | Clear, no | Clear, no |
| | | | | | | loss of | loss of | loss of | loss of |
| | | | | | | original | original | original | original |
| | | | | | | brass | brass | brass | brass |
| | | | | | | brilliance | brilliance | brilliance | brilliance, |
| | | | | | | | | | very |
| | | | | | | | | | slight |
| | | | | | | | | | blue |
| 76 | 3.0 | 0.1 | 2.0 | 0.6 | 1000 | Clear, no | Clear, no | Clear, no | Clear, |
| | | | | | | loss of | loss of | loss of | no |
| | | | | | | original | original | original | loss of |
| | | | | | | brass | brass | brass | original |
| | | | | | | brilliance | brilliance | brilliance | brass |
| | | | | | | | | | brilliance, |
| | | | | | | | | | very |
| | | | | | | | | | slight |
| | | | | | | | | | blue |
| 77 | 5.0 | 0.1 | 2.0 | 0.6 | 1000 | Clear, no | Clear, no | Clear, no | Clear, |
| | | | | | | loss of | loss of | loss of | Very |
| | | | | | | original | original | original | Slight |
| | | | | | | brass | brass | brass | Green |
| | | | | | | brilliance | brilliance | brilliance | And |
| | | | | | | | | | slight |
| | | | | | | | | | off |
| | | | | | | | | | color |
| 78 | 2.0 | 0 | 2.0 | 0.6 | 1000 | Clear, no | Clear, no | Clear, no | Clear, |
| | | | | | | loss of | loss of | loss of | no |
| | | | | | | original | original | original | loss of |
| | | | | | | brass | brass | brass | original |
| | | | | | | brilliance | brilliance | brilliance | brass |
| | | | | | | | | | brilliance, |
| | | | | | | | | | very |
| | | | | | | | | | slight |
| | | | | | | | | | blue |
| 79 | 2.0 | 0.2 | 2.0 | 0.6 | 1000 | Clear, no | Clear, no | Clear, no | Clear, |
| | | | | | | loss of | loss of | loss of | Verys |
| | | | | | | original | original | original | Light |
| | | | | | | brass | brass | brass | Green |
| | | | | | | brilliance | brilliance | brilliance | And |
| | | | | | | | | | slight |
| | | | | | | | | | off |
| | | | | | | | | | color |

A stainless steel washer was used to further exemplify the non-corrosive nature of the inventive anti-microbial formulations. The stainless steel washer is a 5/16 split lock washer manufactured by the Hillman Fastener Company of Cincinnati, Ohio. It is not a high grade of stainless steel that would be used in, for example, surgical or dental instruments or endoscopes. Therefore this is also is a demanding test in that this grade of stainless steel would be expected to corrode sooner and with less chemical interaction than the higher grade stainless steel used in medical applications. In this test the stainless steel 5/16 split lock washer replaces the piece of steel wool that was used in the ferrous metal corrosion test and the test was conducted in the same manner.

Table 7 below shows that the antimicrobial formulations of the present invention do not corrode or oxidize stainless steel. To be a viable anti-microbial formulation, it should not cause any corrosion to stainless steel in less than a 67 hour period at room temperature. The antimicrobial formulations of the present invention pass the iron and the copper and the brass and the stainless steel corrosion tests. Commercial antimicrobial formulations based upon the prior art corrode iron, copper, brass or stainless steel, or two of the metals, three of the metals, or all four of the metals. Corrosion of any of these four metals is unacceptable because of the wide spread use of ferrous metals and copper and brass and stainless steel in items, articles and surfaces that are treated with antimicrobial formulations. This type of corrosion will ruin these items, articles and surfaces that are treated with antimicrobial formulations resulting in costly repair or replacement. In addition corrosion is often accompanied by an increase in surface roughness which makes subsequent disinfecting more difficult. This is an undesirable situation. The other tables that follow use the same corrosion test protocol.

TABLE 7
Stainless Steel Corrosion/Oxidation Test Results for Antimicrobial Formulations of
the Present Invention

| | | | | | | | Corrosion | Corrosion | Corrosion |
|---|---|---|---|---|---|---|---|---|---|
| | Weight % | Weight % | Weight % | Weight % | ppm | Corrosion | after | after | after |
| | BioSoft | citric | Hydrogen | Peracetic | silver | after 2 | 19 | 43 | 67 |
| Example # | S101 | acid | peroxide | acid | nitrate | hours | hours | hours | hours |
| 80 | 2.0 | 0.1 | 2.0 | 0.6 | 1000 | Clear, | Clear, | Clear, | Clear, |
| | | | | | | No | no | no | no |
| | | | | | | corrosion | corrosion | corrosion | corrosion |
| 81 | 3.0 | 0.1 | 2.0 | 0.6 | 1000 | Clear, | Clear, | Clear, | Clear, |
| | | | | | | No | no | no | no |
| | | | | | | corrosion | corrosion | corrosion | corrosion |
| 82 | 5.0 | 0.1 | 2.0 | 0.6 | 1000 | Clear, | Clear, | Clear, | Clear, |
| | | | | | | no | no | no | no |
| | | | | | | corrosion | corrosion | corrosion | corrosion |
| 83 | 2.0 | 0 | 2.0 | 0.6 | 1000 | Clear, | Clear, | Clear, | Clear, |
| | | | | | | no | No | no | no |
| | | | | | | corrosion | corrosion | corrosion | corrosion |
| 84 | 2.0 | 0.2 | 2.0 | 0.6 | 1000 | Clear, | Clear, | Clear, | Clear, |
| | | | | | | no | no | no | no |
| | | | | | | corrosion | corrosion | corrosion | corrosion |

An aluminum corrosion/oxidation test was performed using a piece of Reynolds Wrap® Quality Aluminum Foil, about one square inch in size, to further exemplify the non-corrosive nature of the inventive anti-microbial formulations. In this test the piece of aluminum foil replaces the piece of steel wool that was used in the ferrous metal corrosion test and the test was conducted in the same manner.

Table 8 below shows that the antimicrobial formulations of the present invention do not corrode or oxidize aluminum. All of these examples are also not corrosive to ferrous metals. To be a viable anti-microbial formulation, it should not cause any corrosion to aluminum in less than a 67 hour period at room temperature. The antimicrobial formulations of the present invention pass the iron, the copper, the brass, the stainless steel and the aluminum corrosion tests. Commercial antimicrobial formulations based upon the prior art corrode iron, copper, brass, stainless steel or aluminum, or two of the metals, three of the metals, four of these metals or all five of the metals. Corrosion of any of these five metals is unacceptable because of the wide spread use of ferrous metals and copper and brass and stainless steel and aluminum in items, articles and surfaces that are treated with antimicrobial formulations. This type of corrosion will ruin these items, articles and surfaces that are treated with antimicrobial formulations resulting in costly repair or replacement. In addition when corrosion occurs it means that the antimicrobial formulation is reacting with the metal and this process will consume the peroxy components and reduce the efficacy of the antimicrobial formulation. This is an undesirable situation.

In addition to metals the antimicrobial formulations of the present invention do not destroy or compromise the integrity of glass, polyethylene, polypropylene, Teflon, polystyrene and pigmented polyvinyl chloride. These materials were in contact with formulations of the present invention and upon visual inspection showed no signs of swelling, crazing, discoloration or loss of material integrity. This is an important feature because of the wide spread use of glass and these type of synthetic materials in the construction of items, articles and surfaces that are treated with antimicrobial formulations in the household, commercial, personal care, food processing and health care areas.

TABLE 8
Aluminum Corrosion/Oxidation Test Results for Antimicrobial Formulations of the
Present Invention

| | | | | | | | Corrosion | Corrosion | Corrosion |
|---|---|---|---|---|---|---|---|---|---|
| | Weight % | Weight | Weight % | Weight % | ppm | Corrosion | after | after | after |
| | BioSoft | % citric | Hydrogen | Peracetic | silver | after 2 | 19 | 43 | 67 |
| Example # | S101 | acid | peroxide | acid | nitrate | hours | hours | hours | hours |
| 85 | 2.0 | 0.1 | 2.0 | 0.6 | 1000 | Clear, | Clear, | Clear, | Clear, |
| | | | | | | no | no | no | no |
| | | | | | | corrosion | corrosion | corrosion | corrosion |
| 86 | 3.0 | 0.1 | 2.0 | 0.6 | 1000 | Clear, | Clear, | Clear, | Clear, |
| | | | | | | no | no | no | no |
| | | | | | | corrosion | corrosion | corrosion | corrosion |
| 87 | 5.0 | 0.1 | 2.0 | 0.6 | 1000 | Clear, | Clear, | Clear, | Clear, |
| | | | | | | no | no | no | no |
| | | | | | | corrosion | corrosion | corrosion | corrosion |
| 88 | 2.0 | 0 | 2.0 | 0.6 | 1000 | Clear, | Clear, | Clear, | Clear, |
| | | | | | | no | no | no | no |
| | | | | | | corrosion | corrosion | corrosion | corrosion |
| 89 | 2.0 | 0.2 | 2.0 | 0.6 | 1000 | Clear, | Clear, | Clear, | Clear, |
| | | | | | | no | no | no | no |
| | | | | | | corrosion | corrosion | corrosion | corrosion |

### Uses of the Anti-Microbial Formulations of the Present Invention

The antimicrobial formulations of the present invention have broad spectrum effectiveness, rapid speed to kill, stability, residual efficacy, and are noncorrosive to metals, especially to ferrous metals. They can be used to eradicate harmful microorganisms in a variety of applications. The anti-microbial formulations of the present invention can be applied in any context—to an object (both living and non-living, as well as fluid and solid), on a surface of an object, or into an enclosed space—as a liquid, a froth, a foam, a spray, a mist or a fog. An object, as used herein, means any visible or tangible item and may be indoors and/or outdoors, airborne, in outer space, in or underwater, or underground. The anti-microbial formulations of the present invention can be used as, but are not limited to, cleaners, washes, disinfectants, sanitizers, antiseptics, sterilants, bactericides, sporicides, fungicides, virucides, mildewicides, mold eradicators, mycobactericides or biocides in instances including, but not limited to, where vegetative or spore forms of harmful or infectious microorganisms need to be reduced or eliminated by applying onto inanimate surfaces or surfaces that are alive. Biofilms are also eliminated by antimicrobial formulations of the present invention.

The concentrated antimicrobial compositions of the antimicrobial formulations of the present invention above can typically be used as prepared or diluted with water in any concentration or proportion, including but not limited to, from 1:2, to 1:10, 1:100, or even higher. Concentrated formulations can be used, for example, to treat large quantities of water—waste water, industrial water, cooling water, municipal water.

Living objects include, but are not limited to, animals (e.g., humans, dogs, cats, horses, etc.) and plants (e.g., grass, trees, fruits, vegetables, etc.). When used by a human, the anti-microbial formulations of the present invention can be applied onto any body part or parts, including but not limited to, skin, nails, fingers, toes, teeth, gums, throat, tongue or hair. Prior to surgery the anti-microbial formulations of the present invention can be applied to the skin to prevent surgical site infections. These formulations can also be applied to accelerate the healing of wounds, cuts, abrasions and burns.

In the oral care arena the anti-microbial formulations of the present invention can be used as a mouthwash and to maintain healthy gums, teeth, prevent mouth sores or mitigate the severity of mouth sores and sore throats and also prevent halitosis. These formulations can also be used to brighten or whiten teeth. The anti-microbial formulation of the present invention can also be used as an additive for products used in the above applications to reduce or eliminate harmful microorganisms or prevent the new growth of harmful microorganisms.

In animals other than humans, the anti-microbial formulations of the present invention can be applied on any body part or parts, including but not limited to, fur, hooves, hide, horns or skin. The anti-microbial formulations of the present invention can also be used in animal husbandry, animal care, and confined animal feeding areas.

With non-living objects in the health care field, the anti-microbial formulations of the present invention can be applied to any surface, including but not limited to, surfaces in the surgical theater, on surgical equipment, on diagnostic equipment, on catheters, and on endoscopes. These formulations can also be used in hospital rooms, bathrooms, and hallways, where textiles, wood, stone, concrete, ceramics, tiles, metals, hard and flexible plastics, and elastomeric surfaces and objects need to be treated to reduce or eliminate harmful or infectious microorganisms. Household, commercial and military objects can also be treated to eliminate harmful microorganisms.

With objects in the food and beverage area, the anti-microbial formulations of the present invention can be used in any area, including but not limited to, the areas where processing, preparing, packaging, and storage operations occur. The anti-microbial formulation of the present invention can be used also to treat objects in this field, such as but not limited to, liquids, beverages, and water, that have been contaminated with harmful microorganisms, so as to render these objects safe for use. The anti-microbial formulation of the present invention can be also be used also to decontaminate, purify, or preserve these objects.

In addition to living and non-living objects, the anti-microbial formulations of the present invention can be applied to enclosed spaces and object contained within, such as but not limited to, rooms, storage areas, living areas, recreation areas, closets, and air condition and ventilation ducts. Such enclosed spaces may be fully or partially enclosed.

The anti-microbial formulation of the present invention can be added to either aqueous or organic liquids to eliminate or reduce harmful microorganisms and or eliminate biofilms, to render them safe for use, to decontaminate, to purify or preserve, or to deliver the anti-microbial action/efficacy of the anti-microbial formulations of the present invention for a specific application. These aqueous or organic liquids can be formulations originally designed for use with these antimicrobial formulations, or may be formulations originally designed for other applications in which the addition of the anti-microbial formulations of the present invention alter or enhance the properties of the original formulation. For example, the anti-microbial formulations of the present invention can be added to a soap formulation to produce a new antimicrobial soap formulation or a tooth paste to produce a new tooth paste that can eliminate harmful microorganisms and biofilms.

The anti-microbial formulation of the present invention can be used for many purposes, including but not limited to, to remove microorganisms from objects or enclosed spaces, or as a preservative to prevent future contamination and/or degradation by harmful microorganisms for objects such as but not limited to, paper, leather, paint, wood, wood products, fabrics (both natural and synthetic fibers), plastics, cellulosics, adhesives, waxes, paper and pulp slurries, carpets and carpet backings, and synthetic and natural latexes.

The objects and enclosed spaces where the anti-microbial formulation of the present invention can be applied or used include, but are not limited to, both on the surface and inside of a building, a body cavity of an animal, and a vehicle. Examples of a body cavity of an animal include, but are not limited to, an oral cavity, a sinus cavity, etc. Examples of vehicles include, but are not limited to, a car, a truck, a train, a boat, a ship, a plane, and a space craft. The anti-microbial formulation of the present invention can also be used or applied in the outdoor environment. Examples include, but are not limited to, the eradication of microorganisms on the exterior of buildings, sidewalks, stairs, railings, pavement, trees, poles and posts, curbs, roofs, pipes, playground, recreational and exercise equipment and objects, surfaces or items in space—outside the earth's atmosphere.

Gram positive, Gram negative, virus, mold, mildew, fungi, and spores and biofilms are eradicated by the anti-microbial formulations of the present invention. The formulations of the present invention have residual efficacy against aspergillus niger spores for at least 1 day. It is preferred that the formulations of the present invention have residual efficacy against aspergillus niger spores for at least 2 days. It is most preferred that the formulations of the present invention have residual efficacy against aspergillus niger spores for at least 3 days. As stated earlier, Apergillus niger is an exceptionally difficult spore to kill.

### Formulation Kill Efficacy Examples and Results

Examples were prepared and tested for efficacy in killing S. aureus and E. coli. The preparation and results of these examples are described below. The compositions of the examples are described in the text and tables earlier in this work

### Examples 1-15

The compositions of these examples were described earlier in the text of this work. These examples were prepared in a 250 ml beaker by sequentially adding the ingredients listed in the text of these examples with manual stirring between sequential additions. These examples show that the dodecylbenzene sulfonic acid surfactant (Biosoft S101) has a powerful ability to prevent the precipitation of silver from ordinary tap water. The dodecylbenzene sulfonic acid surfactant (Biosoft S101) should be present in the aqueous formulation before the silver is added to prevent the precipitation of silver from ordinary tap water.

### Examples 16-23 and 43-47

These are Commercially Available Antimicrobial formulations based upon the prior art which are corrosive. These formulations were purchased and are described in Table 1 and Table 3.

Time to kill results for formulations are shown in the tables below. The term cfu is an abbreviation for ‘colony forming units.’

Time to Kill results for Example 18, Oxivir—diluted 1:2 with 4% protein broth. The results show that this commercial antimicrobial is inferior to the antimicrobials of the present invention because it takes 10 minutes to kill the E. Coli. (see results tables for selected formulations from examples 25 through 89).

| Time (min) | S. aureus (cfu) | E. coli (cfu) |
|---|---|---|
| 1 | Many cfus | Many cfus |
| 5 | 0 | Many cfus |
| 10 | 0 | 0 |

Time to Kill results for Example 20, Germ Control 24—diluted 1:2 with 4% protein broth. The results show that this commercial antimicrobial is inferior to the antimicrobials of the present invention, (see results tables for selected formulations from examples 25 through 89).

| Time (min) | S. aureus (cfu) | E. coli (cfu) |
|---|---|---|
| 1 | Many cfus | Many cfus |
| 5 | 0 | Many cfus |
| 10 | 0 | 0 |

### Examples 24, 56

Composition—about 0.1% Biosoft S101, 2.1% citric acid, 2.0% hydrogen peroxide, 0.6% peracetic acid, 1000 ppm (parts per million) silver nitrate. A 250 ml beaker equipped with a magnetic stir bar was charged with 79.77 grams of tap water (Newark, N.J. municipal water) containing 100 ppm sodium pyrophosphate and 100 ppm sodium stannate and 0.11 grams of Biosoft S101 surfactant (dodecylbenzene sulfonic acid) and stirred at room temperature for 5 minutes to give a clear solution. Stirring was continued and 6.37 grams of 30% hydrogen peroxide was added and stirred at room temperature for 5 minutes. Stirring was continued and 10.03 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 2.09 grams of citric acid was added and stirred for 5 minutes at room temperature. After dissolving the citric acid, 1.79 grams of 35% peracetic acid was added and stirred for 15 minutes at room temperature. Total of 100 grams with a pH of about 0.5 (pH paper measurement using Baker-pHIX® Universal pH Indicator Sticks for the 0 to 6 pH range, available from Thomas Scientific). This antimicrobial formulation was stored in a high density polyethylene bottles and is ready to use. This antimicrobial formulation is stable and does not degas or build up pressure upon storage. Peracetic acid while charged in this formulation to about 0.6% level reequilibrates upon standing to about a 0.1 to 0.2% level as measured by iodometric titration methods. This titration method will provide varying results as to the level of peracetic acid depending upon the temperature at which the titration is conducted and the length of time elapsed during the titration. Therefore, to eliminate confusion and variability in the expression of the peracetic acid level, the peracetic acid level is expressed in terms of the amount charged into the formulation during preparation for the antimicrobial formulations of the present invention.

### Examples 25, 57

Composition—about 0.1% Biosoft S101, 2.1% citric acid, 2.0% hydrogen peroxide, 0.6% peracetic acid, 1000 ppm silver nitrate. A 250 ml beaker equipped with a magnetic stir bar was charged with 79.75 grams of tap water (Newark, N.J. municipal water) containing 100 ppm sodium pyrophosphate and 100 ppm sodium stannate and 0.12 grams of Biosoft S101 surfactant and stirred at room temperature for 5 minutes to give a clear solution. Stirring was continued and 6.36 grams of 30% hydrogen peroxide was added and stirred at room temperature for 5 minutes. Stirring was continued and 2.13 grams of citric acid was added and stirred for 5 minutes at room temperature. After dissolving the citric acid, 1.81 grams of 35% peracetic acid was added and stirred for 15 minutes at room temperature. Stirring was continued and 10.08 grams of a 1% aqueous silver nitrate solution (prepared by adding 0.5 grams of silver nitrate to 49.5 grams of water and manually stirred for 5 minutes at room temperature) was added and stirred at room temperature for 15 minutes. Total of 100 grams with a pH of about 0.5 (pH paper measurement). This antimicrobial formulation was stored in a high density polyethylene bottles and is ready to use. This antimicrobial formulation is stable and does not degas or build up pressure upon storage. This example shows that the silver can be added in the final step to a peroxy containing antimicrobial formulation.

In addition to assessing the stability of the antimicrobial formulations of the present invention by monitoring the pressure build up in storage bottles the active peroxy compounds have been titrated before and after accelerated heat aging to determine the amount of peroxy compounds in samples of the antimicrobial formulations of the present invention. Ceric sulfate and iodometric titrations with sodium thiosulfate can be used. These are standard titration methods and are described in the web site of FMC Corporation of Philadelphia, Pa. and the Lamotte Company of Charlestown, Md. In the accelerated heat aged test about 50 ml of formulation Example 25 was placed in a 60 ml Nalgene autoclavable narrow mouth polypropylene bottle available from Thomas Scientific. The bottle was sealed with black vinyl electrical tape and contents were placed in an approximate 41° C. oven for the aging study. After storage in the oven for 58 days which simulates about 1.25 years at room temperature, the sample had retained about 87% of the original active peroxy components. This heat aged sample was also evaluated for efficacy in a time to kill study shown below.

Time to Kill results for Example 25, 57 after heat aging—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

These results show that the antimicrobial formulation of the present invention maintains its efficacy after an accelerated heat aging test indicative of superior performance.

### Examples 26, 58

Composition—about 0.1% Biosoft S101, 1.8% citric acid, 2.0% hydrogen peroxide, 0.6% peracetic acid, 1000 ppm silver nitrate. A 250 ml beaker equipped with a magnetic stir bar was charged with 80.06 grams of tap water (Newark, N.J. municipal water) containing 100 ppm sodium pyrophosphate and 100 ppm sodium stannate and 0.12 grams of Biosoft S101 surfactant (dodecylbenzene sulfonic acid) and stirred at room temperature for 5 minutes to give a clear solution. Stirring was continued and 6.35 grams of 30% hydrogen peroxide was added and stirred at room temperature for 5 minutes. Stirring was continued and 10.02 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.82 grams of citric acid was added and stirred for 5 minutes at room temperature. After dissolving the citric acid, 1.83 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

In addition to assessing the stability of the antimicrobial formulations of the present invention by monitoring the pressure build up in storage bottles the active peroxy compounds have been titrated before and after accelerated heat aging to determine the amount of peroxy compounds in samples of the antimicrobial formulations of the present invention. Ceric sulfate and iodometric titrations with sodium thiosulfate can be used. These are standard titration methods and are described in the web site of FMC Corporation of Philadelphia, Pa. and the Lamotte Company of Charlestown, Md. In the accelerated heat aged test about 50 ml of formulation Example 26 was placed in a 60 ml Nalgene autoclavable narrow mouth polypropylene bottle available from Thomas Scientific. The bottle and contents were placed in an approximate 41° C. oven for the aging study. After storage in the oven for 58 days which simulates about 1.25 years at room temperature, the sample had retained about 89% of the original active peroxy components. This heat aged sample was also evaluated for efficacy in a time to kill study shown below.

Time to Kill results for Example 26, 58 after heat aging—diluted 1:2 with 4% protein broth. The composition is effective to exhibit a time to kill of 5 minutes or less, and preferably a time to kill of 1 minute or less against each of Staphylococcus aureus ATCC 6538, Escherichia coli ATCC 8739 when diluted 1 to 2 with a 4% human protein broth. The results exemplify outstanding time to kill. These results also indicate that this antimicrobial maintains its efficacy even in the presence of protein or organic soil.

| Time (min) | S. aureus (cfu) | E. coli (cfu) | |
|---|---|---|---|
| 1 | 0 | 20 | cfu |
| 5 | 0 | 2 | cfu |
| 10 | 0 | 0 | |

These results show that the antimicrobial formulation of the present invention maintains its efficacy after an accelerated heat aging test indicative of superior performance.

### Examples 27, 73

Composition—about 0.1% Biosoft S101, 2.1% citric acid, 2.0% hydrogen peroxide, 0.6% peracetic acid, 1000 ppm silver nitrate. A 31 flask equipped with a magnetic stir bar was charged with 983.84 grams of tap water (Chemy Hill, N.J. municipal water) containing 150 ppm sodium pyrophosphate and 2.29 grams of Biosoft S101 surfactant and stirred at room temperature for 15 minutes to give a clear solution. Stirring was continued and 46.19 grams of citric acid was added and stirred for 20 minutes at room temperature. After dissolving the citric acid, stirring was continued and 1085.39 grams of 35% hydrogen peroxide was added and stirred at room temperature for 15 minutes. Then 89.76 grams of 15% peracetic acid was added and stirred for 15 minutes at room temperature. A 100.13 gram portion of the above antimicrobial formulation was placed in a 250 ml beaker with a magnetic stir bar. Stirring was continued and 10.11 grams of a 1% aqueous silver nitrate solution (prepared by adding 0.5 grams of silver nitrate to 49.5 grams of water and manually stirred for 5 minutes at room temperature) was added and stirred at room temperature for 15 minutes. Total of 110 grams with a pH of about 0.5 (pH paper measurement). This antimicrobial formulation was stored in a high density polyethylene bottles and is ready to use. This antimicrobial formulation is stable and does not degas or build up pressure upon storage. This example shows that the silver can be added to a previously prepared peroxy containing antimicrobial formulation and result in an antimicrobial formulation of the present invention with excellent efficacy.

Time to kill Staphylococcus aureus and Escherichia coli experimental methods and results are described below.

This approach to examine bactericidal activity involves exposing a bacterial isolate (such as Staphylococcus aureus or Escherichia coli or other microorganism) to a concentration of antimicrobial in a broth medium at any desired dilution and then measuring the rate of killing over a specified period of time. By this time-kill analysis, samples are taken from the antimicrobial-broth solution immediately after the inoculum was added and at regular intervals thereafter. For example, a typical time sequence might be aliquots to be taken at 0, 1, 3, 5, and 10 minutes, etc., for culture. Any time sequence desired can obviously be substituted depending upon the purpose of the experiment. Each time-sample is then plated onto agar plates which are, in turn, incubated overnight at 35 C and observed for growth. Following incubation, the colonies are counted and expressed as CFU's/ml (colony-forming units per milliliter). These can then be compared to the original inoculum (0 control) in order to determine the logarithmic decrease in growth and therefore the efficacy of the antimicrobial formulation. In these tests about 10⁶ to 10⁷ cfu were used and the example formulations were tested after a 1 to 2 dilution with a 4% human protein broth. The results are given below for the specific examples. A “0” rating in the following tables indicates that all the microorganisms were killed at the time indicated and is indicative of a very efficacious antimicrobial. The controls having no antimicrobial formulation for these test had many cfu's of the microorganism remaining in the time to kill test.

Time to Kill results for Example 27, 73—diluted 1:2 with 4% protein broth. The results exemplify outstanding time to kill. These results also indicate that this antimicrobial maintains its efficacy even after dilution in the presence of protein or organic soil. These results indicate that the antimicrobial formulations of the present invention are very robust and can tolerate dilution and the presence of protein which mimics procedural and environmental excursions in the use of these antimicrobials. Antimicrobials based upon the current state of the art usually cannot tolerate both of these procedural and environmental excursions.

| | S. | | | Pseudomonas | Salmonella |
|---|---|---|---|---|---|
| Time | aureus | E. coli | Acinetobacter | aeruginosa | cholerasuis |
| (min) | (cfu) | (cfu) | bauminii (cfu) | (cfu) | (cfu) |
| 1 | 0 | 0 | 0 | 0 | 0 |
| 5 | 0 | 0 | 0 | 0 | 0 |
| 10 | 0 | 0 | 0 | 0 | 0 |

Time to Kill Spores Results for Example 27, 73—this time to kill was conducted against Bacillus anthracis at 10⁵ cfu and about 30% spores, Aspergillus niger at 15 cfu and about 15% spores with undiluted antimicrobial formulation. In this test the control had many cfu.

| | Bacillus anthracis | Aspergillus niger |
|---|---|---|
| Time | spores | spores |
| 1 minute | Many cfu | Many cfu |
| 5 mins | Many cfu | Many cfu |
| 10 mins | Many cfu | Many cfu |
| 20 mins | Many cfu | Many cfu |
| 30 mins | Many cfu | Many cfu |
| 1 hour | 1 cfu | 1 cfu |
| 2 hrs | 0 | 0 |
| 3 hrs | 0 | 0 |
| 4 hrs | 0 | 1 cfu |
| 6 hrs | 0 | 0 |
| 12 hrs | 0 | 0 |
| 20 hrs | 0 | 0 |

Formulations in examples 27 and 73 were tested on Herpes virus, ATCC VR733, which was completely eliminated by this formulation. No viable cells remain after contact of the antimicrobial formulation of the present invention and the herpes virus.

Time to kill studies shown below were also conducted against multi-drug resistant microorganisms.

Time to Kill results for Example 27, 73 against multi-drug resistant microorganisms—diluted 1:2 with 4% protein broth. The results exemplify outstanding time to kill. These results also indicate that this antimicrobial maintains its efficacy even in the presence of protein or organic soil.

| | Methicillan | | |
|---|---|---|---|
| | resistant | Drug resistant | Drug resistant |
| | Staphylococcus | ESBL Klebsiella | Enterobacter |
| Time (min) | aureus (cfu) | pneumoniae (cfu) | cloacae |
| 1 | 0 | 0 | 0 |
| 5 | 0 | 0 | 0 |
| 10 | 0 | 0 | 0 |

These results show that the antimicrobial formulation of the present invention has superior efficacy even against harmful multi-drug resistant microorganisms.

These efficacy and time to kill results indicate that the antimicrobial formulations of the present invention are very effective at eradicating a wide variety of harmful microorganisms including very difficult to kill spore forms of microorganisms, difficult to kill viruses, and multidrug resistant microorganisms. These time to kill results indicate that the silver antimicrobial formulations of the present invention are sporicidal and have broad spectrum efficacy. These results for the antimicrobial formulations of the present invention are consistent with the efficacy of an antimicrobial for use as a sanitizer, disinfectant, a high level disinfectant or a cold sterilant.

### Examples 28, 60

Composition—about 2.0% Biosoft S101, 0.2% citric acid, 2.0% hydrogen peroxide, 0.6% peracetic acid, 1000 ppm silver nitrate. A 250 ml beaker equipped with a magnetic stir bar was charged with 39.86 grams of tap water (Newark, N.J. municipal water) containing 100 ppm sodium pyrophosphate and 100 ppm sodium stannate and 1.07 grams of Biosoft S101 surfactant (dodecylbenzene sulfonic acid) and stirred at room temperature for 5 minutes to give a clear solution. Stirring was continued and 3.22 grams of 30% hydrogen peroxide was added and stirred at room temperature for 5 minutes. Stirring was continued and 5.01 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.10 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 29, 59

Composition—about 2.0% Biosoft S101, 2.0% citric acid, 2.0% hydrogen peroxide, 0.6% peracetic acid, 1000 ppm silver nitrate. A 250 ml beaker equipped with a magnetic stir bar was charged with 39.54 grams of tap water (Newark, N.J. municipal water) containing 100 ppm sodium stannate and 1.07 grams of Biosoft S101 surfactant (dodecylbenzene sulfonic acid) and stirred at room temperature for 5 minutes to give a clear solution. Stirring was continued and 3.21 grams of 30% hydrogen peroxide was added and stirred at room temperature for 5 minutes. Stirring was continued and 5.02 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.04 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 30, 61

Composition—about 2.0% Biosoft S101, 0.2% citric acid, 2.0% hydrogen peroxide, 0.6% peracetic acid, 1000 ppm silver nitrate. A 250 ml beaker equipped with a magnetic stir bar was charged with 39.84 grams of tap water (Newark, N.J. municipal water) containing 100 ppm sodium pyrophosphate and 100 ppm sodium stannate and 1.03 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.02 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.14 grams of citric acid was added and stirred for 5 minutes at room temperature. After dissolving the citric acid, 0.89 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 30, 61—diluted 1:2 with 4% protein serum. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Examples 31, 62

Composition—about 2.0% Biosoft S101, 0.2% citric acid, 2.0% hydrogen peroxide, 0.6% peracetic acid, 1000 ppm silver nitrate. A 250 ml beaker equipped with a magnetic stir bar was charged with 39.82 grams of tap water (Newark, N.J. municipal water) containing 100 ppm sodium stannate and 1.06 grams of Biosoft S101 surfactant (dodecylbenzene sulfonic acid) and stirred at room temperature for 5 minutes to give a clear solution. Stirring was continued and 3.16 grams of 30% hydrogen peroxide was added and stirred at room temperature for 5 minutes. Stirring was continued and 5.08 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.11 grams of citric acid was added and stirred for 5 minutes at room temperature. After dissolving the citric acid, 0.87 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 32, 63

Composition—about 2.0% Biosoft S101, 0.2% citric acid, 2.0% hydrogen peroxide, 0.6% peracetic acid, 1000 ppm silver nitrate. A 250 ml beaker equipped with a magnetic stir bar was charged with 39.90 grams of tap water (Newark, N.J. municipal water) containing 100 ppm sodium pyrophosphate and 1.07 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.03 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.13 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 33, 64, 79, 84, 89

Composition—about 2.0% Biosoft S101, 0.2% citric acid, 2.0% hydrogen peroxide, 0.6% peracetic acid, 1000 ppm silver nitrate. A 250 ml beaker equipped with a magnetic stir bar was charged with 39.85 grams of tap water (Newark, N.J. municipal water) and 1.05 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.03 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.10 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage. This example demonstrates that peroxy stabilizers are not needed to prepare antimicrobial formulations of the present invention, only plain tap water with no additives is needed.

### Examples 34, 69, 75, 80, 85

Composition—about 2.0% Biosoft S01, 0.1% citric acid, 2.0% hydrogen peroxide, 0.6% peracetic acid, 1000 ppm silver nitrate. A 250 ml beaker equipped with a magnetic stir bar was charged with 39.88 grams of tap water (Newark, N.J. municipal water) containing 100 ppm sodium pyrophosphate and 100 ppm sodium stannate and 1.06 grams of Biosoft S1101 surfactant (dodecylbenzene sulfonic acid) and stirred at room temperature for 5 minutes to give a clear solution. Stirring was continued and 3.18 grams of 30% hydrogen peroxide was added and stirred at room temperature for 5 minutes. Stirring was continued and 5.04 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.05 grams of citric acid was added and stirred for 5 minutes at room temperature. After dissolving the citric acid, 0.87 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 35, 70, 76, 81, 86

Composition—about 3.0% Biosoft S101, 0.1% citric acid, 2.0% hydrogen peroxide, 0.6% peracetic acid, 1000 ppm silver nitrate. A 250 ml beaker equipped with a magnetic stir bar was charged with 39.36 grams of tap water (Newark, N.J. municipal water) containing 100 ppm sodium pyrophosphate and 100 ppm sodium stannate and 1.66 grams of Biosoft S101 surfactant (dodecylbenzene sulfonic acid) and stirred at room temperature for 5 minutes to give a clear solution. Stirring was continued and 3.20 grams of 30% hydrogen peroxide was added and stirred at room temperature for 5 minutes. Stirring was continued and 5.07 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.04 grams of citric acid was added and stirred for 5 minutes at room temperature. After dissolving the citric acid, 0.89 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 35, 70, 76, 81, 86—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | Few cfu remain |
| 5 | 0 | 0 |
| 10 | 0 | 0 |

### Examples 36, 66

Composition—about 1.0% Biosoft S101′, 0.1% citric acid, 2.0% hydrogen peroxide, 0.6% peracetic acid, 1000 ppm silver nitrate. A 250 ml beaker equipped with a magnetic stir bar was charged with 40.47 grams of tap water (Newark, N.J. municipal water) containing 100 ppm sodium pyrophosphate and 100 ppm sodium stannate and 0.51 grams of Biosoft S101 surfactant (dodecylbenzene sulfonic acid) and stirred at room temperature for 5 minutes to give a clear solution. Stirring was continued and 3.20 grams of 30% hydrogen peroxide was added and stirred at room temperature for 5 minutes. Stirring was continued and 5.06 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.06 grams of citric acid was added and stirred for 5 minutes at room temperature. After dissolving the citric acid, 0.87 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 37, 65

Composition—about 0.5% Biosoft S101, 0.1% citric acid, 2.0% hydrogen peroxide, 0.6% peracetic acid, 1000 ppm silver nitrate. A 250 ml beaker equipped with a magnetic stir bar was charged with 40.69 grams of tap water (Newark, N.J. municipal water) containing 100 ppm sodium pyrophosphate and 100 ppm sodium stannate and 0.28 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.09 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.05 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

### Examples 38, 67

Composition—about 1.5% Biosoft S101, 0.1% citric acid, 2.0% hydrogen peroxide, 0.6% peracetic acid, 1000 ppm silver nitrate. A 250 ml beaker equipped with a magnetic stir bar was charged with 40.15 grams of tap water (Newark, N.J. municipal water) containing 100 ppm sodium pyrophosphate and 100 ppm sodium stannate and 0.79 grams of Biosoft S101 surfactant (dodecylbenzene sulfonic acid) and stirred at room temperature for 5 minutes to give a clear solution. Stirring was continued and 3.17 grams of 30% hydrogen peroxide was added and stirred at room temperature for 5 minutes. Stirring was continued and 5.00 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.06 grams of citric acid was added and stirred for 5 minutes at room temperature. After dissolving the citric acid, 0.89 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 38, 67—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 1 cfu | 0 |
| 5 | 0 | 0 |
| 10 | 0 | 0 |

### Examples 39, 71, 77, 82, 87

Composition—about 5.0% Biosoft S101, 0.1% citric acid, 2.0% hydrogen peroxide, 0.6% peracetic acid, 1000 ppm silver nitrate. A 250 ml beaker equipped with a magnetic stir bar was charged with 38.23 grams of tap water (Newark, N.J. municipal water) containing 100 ppm sodium pyrophosphate and 100 ppm sodium stannate and 2.73 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.08 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.06 grams of citric acid was added and stirred for 5 minutes at room temperature. After dissolving the citric acid, 0.88 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 39, 71, 77, 82, 87—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Examples 40, 68

Composition—about 2.0% Biosoft S101, 0.1% citric acid, 2.0% hydrogen peroxide, 0.6% peracetic acid, 1000 ppm silver nitrate. A 250 ml beaker equipped with a magnetic stir bar was charged with 79.79 grams of tap water (Newark, N.J. municipal water) containing 100 ppm sodium pyrophosphate and 100 ppm sodium stannate and 2.07 grams of Biosoft S101 surfactant (dodecylbenzene sulfonic acid) and stirred at room temperature for 5 minutes to give a clear solution. Stirring was continued and 6.37 grams of 30% hydrogen peroxide was added and stirred at room temperature for 5 minutes. Stirring was continued and 10.03 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.11 grams of citric acid was added and stirred for 5 minutes at room temperature. After dissolving the citric acid, 1.76 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

In addition to assessing the stability of the antimicrobial formulations of the present invention by monitoring the pressure build up in storage bottles the active peroxy compounds have been titrated before and after accelerated heat aging to determine the amount of peroxy compounds in samples of the antimicrobial formulations of the present invention. Ceric sulfate and iodometric titrations with sodium thiosulfate can be used. These are standard titration methods and are described in the web site of FMC Corporation of Philadelphia, Pa. and the Lamotte Company of Charlestown, Md. In the accelerated heat aged test about 50 ml of formulation Example 40 was placed in a 60 ml Nalgene autoclavable narrow mouth polypropylene bottle available from Thomas Scientific. The bottle and contents were placed in an approximate 41° C. oven for the aging study. After storage in the oven for 23 days which simulates about 0.5 years at room temperature, the sample had retained about 95% of the original active peroxy components. This heat aged sample was also evaluated for efficacy in a time to kill study shown below.

Time to Kill results for Example 40, 68 after heat aging—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 1 cfu |
| 5 | 0 | 1 cfu |
| 10 | 0 | 0 |

These results show that the antimicrobial formulation of the present invention maintains its efficacy after an accelerated heat aging test indicative of superior performance.

### Examples 41, 72, 78, 83, 88

Composition—about 2.0% Biosoft SI 01, 0.0% citric acid, 2.0% hydrogen peroxide, 0.6% peracetic acid, 1000 ppm silver nitrate. A 250 ml beaker equipped with a magnetic stir bar was charged with 39.94 grams of tap water (Newark, N.J. municipal water) containing 100 ppm sodium pyrophosphate and 100 ppm sodium stannate and 1.05 grams of Biosoft S101 surfactant (dodecylbenzene sulfonic acid) and stirred at room temperature for 5 minutes to give a clear solution. Stirring was continued and 3.22 grams of 30% hydrogen peroxide was added and stirred at room temperature for 5 minutes. Stirring was continued and 4.99 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.86 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 41, 72, 78, 83, 88—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Examples 42, 74

Composition—about 3.0% Biosoft S101, 0.0% citric acid, 2.0% hydrogen peroxide, 0.6% peracetic acid, 1000 ppm silver nitrate. A 250 ml beaker equipped with a magnetic stir bar was charged with 39.37 grams of tap water (Newark, N.J. municipal water) containing 100 ppm sodium pyrophosphate and 100 ppm sodium stannate and 1.61 grams of Biosoft S101 surfactant (dodecylbenzene sulfonic acid) and stirred at room temperature for 5 minutes to give a clear solution. Stirring was continued and 3.19 grams of 30% hydrogen peroxide was added and stirred at room temperature for 5 minutes. Stirring was continued and 5.06 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 0.90 grams of 35% peracetic acid was added and stirred for 15 minutes at room temperature. Total of 50 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 42, 74—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Comparative Example 48

Composition—about 0.1% Biosoft S101, 1.9% citric acid, 2.0% hydrogen peroxide, 0.6% peracetic acid—no silver. A 1000 ml beaker equipped with a magnetic stir bar was charged with 752.01 grams of tap water (Newark, N.J. municipal water) containing 300 ppm sodium pyrophosphate and 1.04 grams of Biosoft S101 surfactant and stirred at room temperature for 15 minutes to give a clear solution. Stirring was continued and 148.11 grams of 5% aqueous acetic acid was added followed by 18.95 grams of citric acid was added and stirred for 20 minutes at room temperature. After dissolving the citric acid, stirring was continued and 62.98 grams of 30% hydrogen peroxide was added and stirred at room temperature for 15 minutes. Then 17.26 grams of 35% peracetic acid was added and stirred for 15 minutes at room temperature. Total of 1000 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 48—diluted 1:2 with 4% protein broth. The results exemplify outstanding time to kill. These results also indicate that this antimicrobial maintains its efficacy even in the presence of protein or organic soil. However, this formulation is corrosive to copper.

| Time (min) | S. aureus (cfu) | E. coli (cfu) |
|---|---|---|
| 1 | 0 | 0 |
| 5 | 0 | 0 |
| 10 | 0 | 0 |

Residual Time to Kill Results for Example 48—with Staphylococcus aureus at 10⁵ to 10⁶ recontamination level. In order to assess the residual activity of the antimicrobial formulation the bottom of sterile Petri dishes were coated with the formulation and allowed to dry (approximately 1-2 hours). A marked section of that coated surface was wetted with an inoculum of 10⁵-10⁶ cfu/ml of Staphylococcus aureus, Escherichia coli or other organism(s) under assessment and allowed to react with the dried antimicrobial formulation. Controls were used that contained no antimicrobial formulation so as to test viability of inoculum. At varied time intervals a sterile bacteriological loop was passed over the surface in 3 plains and then inoculated onto a TSA (trypticase soy blood agar) plate which was incubated over night in ambient air at 36° C. The assay intervals started at 30 min, then occurred as follows 1, 2, 3, 4, 5, 6, 8, 12 and 24 hours. Growth was recorded as follows: 4+ (heavy growth, similar to starting control inoculum), 3+ moderately heavy growth (less than starting control inoculum), 2+ light growth (half or less than starting control inoculum), 1+ (scant growth), 0 (no growth). Residual activity was accessed accordingly.

| | | Staphylococcus aureus |
|---|---|---|
| Time | | Kill |
| 30 | min | 4+ |
| 1 | hour | 4+ |
| 2 | hours | 4+ |
| 3 | hours | 3+ |
| 4 | hours | 2+ |
| 5 | hours | 2+ |

These residual time to kill results indicate that the antimicrobial formulations of the prior art do not have a lasting efficacy after applied and dried and will not continue to eradicate harmful microorganisms when recontaminated.

### Comparative Example 49

Composition—about 0.1% Biosoft S101, 3.0% citric acid, 3.0% hydrogen peroxide, 3.0% peracetic acid—no silver. A 1000 ml beaker equipped with a magnetic stir bar was charged with 442.07 grams of tap water (Newark, N.J. municipal water) containing 150 ppm sodium pyrophosphate and 1.06 grams of Biosoft S101 surfactant and stirred at room temperature for 15 minutes to give a clear solution. Stirring was continued and 360.55 grams of 5% aqueous acetic acid was added followed by 29.99 grams of citric acid was added and stirred for 20 minutes at room temperature. After dissolving the citric acid, stirring was continued and 81.49 grams of 30% hydrogen peroxide was added and stirred at room temperature for 15 minutes. Then 85.78 grams of 35% peracetic acid was added and stirred for 15 minutes at room temperature. Total of 1000 grams with a pH of about 0.5 (pH paper measurement). This antimicrobial formulation was stored in a high density polyethylene bottles and is ready to use. This antimicrobial formulation is stable and does not degas or build up pressure upon storage.

### Comparative Example 50

Composition—about 0.1% Biosoft S101, 2.1% citric acid, 1.9% hydrogen peroxide, 0.6% peracetic acid—no silver. A 250 ml beaker equipped with a magnetic stir bar was charged with 44.03 grams of tap water (Newark, N.J. municipal water) containing 300 ppm sodium pyrophosphate and 0.11 grams of Biosoft S101 surfactant and stirred at room temperature for 5 minutes to give a clear solution. Stirring was continued 2.15 grams of citric acid was added and stirred for 5 minutes at room temperature. After dissolving the citric acid, stirring was continued and 50.00 grams of 3% hydrogen peroxide was added and stirred at room temperature for 15 minutes. Then 4.12 grams of 15% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Comparative Examples 51-55 were prepared in the same manner as comparative example 50 but the quantities of the ingredients were changed to represent the various compositions: comparative example 51 about 0.1% Biosoft S101, 1.8% citric acid, 1.9% hydrogen peroxide, 0.6% peracetic acid—no silver; comparative example 52 about 2.0% Biosoft S101, 0.2% citric acid, 2.0% hydrogen peroxide, 0.6% peracetic acid—no silver; comparative example 53 about 2.0% Biosoft S101, 2.0% citric acid, 2.0% hydrogen peroxide, 0.6% peracetic acid—no silver; comparative example 54 about 2.0% Biosoft S101, 2.0% citric acid, 2.0% hydrogen peroxide, 0.6% peracetic acid—no silver, water contained no peroxy stabilizers; comparative example 55 about 2.0% Biosoft S101, 0.2% citric acid, 2.0% hydrogen peroxide, 0.6% peracetic acid—no silver

### Example 90

Composition—about 0.5% Biosoft S101, 1.8% citric acid, 1.9% hydrogen peroxide, 0.6% peracetic acid, 40 ppm silver nitrate. A 250 ml beaker equipped with a magnetic stir bar was charged with 59.23 grams 3% hydrogen peroxide and 0.50 grams of Biosoft S101 surfactant and stirred at room temperature for 5 minutes to give a clear solution. Stirring was continued and 0.41 grams of a 1% aqueous silver nitrate solution (prepared by adding 0.5 grams of silver nitrate to 49.5 grams of water and manually stirred for 5 minutes at room temperature) was added and stirred at room temperature for 5 minutes and 36.54 grams of tap water containing 300 ppm sodium pyrophosphate was added. Stirring was continued and 1.77 grams of citric acid was added and stirred for 5 minutes at room temperature. After dissolving the citric acid, 1.73 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill results for Example 90—diluted 1:2 with 4% protein broth at 107 to 108 challenge. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Example 91

Composition—about 0.5% Biosoft S101, 1.8% citric acid, 1.9% hydrogen peroxide, 0.6% peracetic acid, 500 ppm silver nitrate. A 250 ml beaker equipped with a magnetic stir bar was charged with 59.25 grams 3% hydrogen peroxide and 0.51 grams of Biosoft S101 surfactant and stirred at room temperature for 5 minutes to give a clear solution. Stirring was continued and 4.99 grams of a 1% aqueous silver nitrate solution (prepared by adding 0.5 grams of silver nitrate to 49.5 grams of water and manually stirred for 5 minutes at room temperature) was added and stirred at room temperature for 5 minutes and 31.91 grams of tap water containing 300 ppm sodium pyrophosphate was added. Stirring was continued and 1.78 grams of citric acid was added and stirred for 5 minutes at room temperature. After dissolving the citric acid, 1.72 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill Results for Example 91—diluted 1:2 with 4% protein broth at 10⁷ to 108 challenge. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

Residual Time to Kill Results for Example 91—with Staphylococcus aureus at 10⁵ to 10⁶ recontamination level. In order to assess the residual activity of the antimicrobial formulation the bottom of sterile Petri dishes were coated with the product and allowed to dry (approximately 1-2 hours). A marked section of that coated surface was wetted with an inoculum of 10⁵ to 10⁶ cfu/ml of Staphylococcus aureus, Escherichia coli or other organism(s) under assessment and allowed to react with the dried antimicrobial formulation. Controls were used that contained no antimicrobial formulation so as to test viability of inoculum. At varied time intervals a sterile bacteriological loop was passed over the surface in 3 plains and then inoculated onto a TSA (trypticase soy blood agar) plate which was incubated over night in ambient air at 36° C. The assay intervals started at 30 min, then occurred as follows 1, 2, 3, 4, 5, 6, 8, 12 and 24 hours. Growth was recorded as follows: 4+(heavy growth, similar to starting control inoculum), 3+ moderately heavy growth (less than starting control inoculum), 2+ light growth (half or less than starting control inoculum), 1+ (scant growth), 0 (no growth). Residual activity was accessed accordingly.

| | | Staphylococcus aureus |
|---|---|---|
| Time | | Kill |
| 30 | min | 1+ |
| 1 | hour | 1+ |
| 2 | hours | 0 |
| 3 | hours | 0 |
| 4 | hours | 0 |
| 5 | hours | 0 |
| 6 | hours | 0 |

These residual time to kill results indicate that the antimicrobial formulations of the present invention have a lasting efficacy after applied and dried and will continue to eradicate harmful microorganisms even when recontaminated. This result shows that the peroxy antimicrobial of the present invention has residual efficacy.

### Example 92

Composition—about 0.5% Biosoft S101, 2.0% citric acid, 2.9% hydrogen peroxide, 50 ppm silver nitrate. A 250 ml beaker equipped with a magnetic stir bar was charged with 97.04 grams 3% hydrogen peroxide and 0.53 grams of Biosoft S101 surfactant and stirred at room temperature for 5 minutes to give a clear solution. Stirring was continued and 0.51 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 2.01 grams of citric acid was added and stirred for 5 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill Results for Example 92—no dilution. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Example 93

Composition—about 0.5% Biosoft S101, 2.0% citric acid, 2.9% hydrogen peroxide, 500 ppm silver nitrate. A 250 ml beaker equipped with a magnetic stir bar was charged with 97.07 grams 3% hydrogen peroxide and 0.51 grams of Biosoft S101 surfactant and stirred at room temperature for 5 minutes to give a clear solution. Stirring was continued and 5.02 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.99 grams of citric acid was added and stirred for 5 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill Results for Example 93—no dilution. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

### Example 94

Composition—about 0.1% Biosoft S101, 1.8% citric acid, 1.9% hydrogen peroxide, 0.6% peracetic acid, 50 ppm silver nitrate. A 250 ml beaker equipped with a magnetic stir bar was charged with 91.03 grams tap water containing 100 ppm sodium pyrophosphate and 5.01 grams 30% hydrogen peroxide and stirred at room temperature for 5 minutes. Then 0.11 grams of Biosoft S101 surfactant are added and stirred at room temperature for 5 minutes to give a clear solution. Stirring was continued and 0.52 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.75 grams of citric acid was added and stirred for 5 minutes at room temperature. After dissolving the citric acid, 1.78 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

### Example 95

Composition—about 0.1% Biosoft S101, 1.8% citric acid, 1.9% hydrogen peroxide, 0.6% peracetic acid, 200 ppm silver nitrate. A 250 ml beaker equipped with a magnetic stir bar was charged with 89.44 grams tap water containing 100 ppm sodium pyrophosphate and 5.10 grams 30% hydrogen peroxide and stirred at room temperature for 5 minutes. Then 0.14 grams of Biosoft S101 surfactant are added and stirred at room temperature for 5 minutes to give a clear solution. Stirring was continued and 2.01 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.74 grams of citric acid was added and stirred for 5 minutes at room temperature. After dissolving the citric acid, 1.75 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill Results for Example 95—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

Residual Time to Kill Results for Example 95—with Staphylococcus aureus at 10⁵ to 10⁶ recontamination level.—In order to assess the residual activity of the antimicrobial formulation the bottom of sterile Petri dishes were coated with the product and allowed to dry (approximately 1-2 hours). A marked section of that coated surface was wetted with an inoculum of 10⁵-10⁶ cfu/ml of Staphylococcus aureus, Escherichia coli or other organism(s) under assessment and allowed to react with the dried antimicrobial formulation. Controls were used that contained no antimicrobial formulation so as to test viability of inoculum. At varied time intervals a sterile bacteriological loop was passed over the surface in 3 plains and then inoculated onto a TSA (trypticase soy blood agar) plate which was incubated over night in ambient air at 36° C. The assay intervals started at 30 min, then occurred as follows 1, 2, 3, 4, 5, 6, 8, 12 and 24 hours. Growth was recorded as follows: 4+ (heavy growth, similar to starting control inoculum), 3+ moderately heavy growth (less than starting control inoculum), 2+ light growth (half or less than starting control inoculum), 1+ (scant growth), 0 (no growth). Residual activity was accessed accordingly.

| | | Staphylococcus aureus |
|---|---|---|
| Time | | Kill |
| 30 | min | 1+ |
| 1 | hour | 1+ |
| 2 | hours | 1+ |
| 3 | hours | 0 |
| 4 | hours | 0 |
| 5 | hours | 0 |
| 6 | hours | 0 |

These residual time to kill results indicate that the antimicrobial formulations of the present invention have a lasting efficacy after applied and dried and will continue to eradicate harmful microorganisms even when recontaminated. This result shows that the peroxy antimicrobial of the present invention has residual efficacy.

### Example 96

Composition—about 0.1% Biosoft S101, 1.8% citric acid, 1.9% hydrogen peroxide, 0.6% peracetic acid, 1000 ppm silver nitrate. A 250 ml beaker equipped with a magnetic stir bar was charged with 81.48 grams tap water containing 100 ppm sodium pyrophosphate and 5.08 grams 30% hydrogen peroxide and stirred at room temperature for 5 minutes. Then 0.12 grams of Biosoft S101 surfactant are added and stirred at room temperature for 5 minutes to give a clear solution. Stirring was continued and 10.03 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 1.77 grams of citric acid was added and stirred for 5 minutes at room temperature. After dissolving the citric acid, 1.76 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

Time to Kill Results for Example 96—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

Residual Time to Kill Results for Example 96—with Staphylococcus aureus at 105 to 10⁶ recontamination level.—In order to assess the residual activity of the antimicrobial formulation the bottom of sterile Petri dishes were coated with the product and allowed to dry (approximately 1-2 hours). A marked section of that coated surface was wetted with an inoculum of 10⁵-10⁶ cfu/ml of Staphylococcus aureus, Escherichia coli or other organism(s) under assessment and allowed to react with the dried antimicrobial formulation. Controls were used that contained no antimicrobial formulation so as to test viability of inoculum. At varied time intervals a sterile bacteriological loop was passed over the surface in 3 plains and then inoculated onto a TSA (trypticase soy blood agar) plate which was incubated over night in ambient air at 36° C. The assay intervals started at 30 min, then occurred as follows 1, 2, 3, 4, 5, 6, 8, 12 and 24 hours. Growth was recorded as follows: 4+ (heavy growth, similar to starting control inoculum), 3+ moderately heavy growth (less than starting control inoculum), 2+ light growth (half or less than starting control inoculum), 1+ (scant growth), 0 (no growth). Residual activity was accessed accordingly.

| | | Staphylococcus aureus |
|---|---|---|
| Time | | Kill |
| 30 | min | 0 |
| 1 | hour | 0 |
| 2 | hours | 0 |
| 3 | hours | 1 cfu |
| 4 | hours | 0 |
| 5 | hours | 0 |
| 6 | hours | 0 |

Residual Time to Kill Results for Example 96—with Listeria monocytogenes at 10⁵ to 10⁶ recontamination level.—In order to assess the residual activity of the antimicrobial formulation the bottom of sterile Petri dishes were coated with the product and allowed to dry (approximately 1-2 hours). A marked section of that coated surface was wetted with an inoculum of 10⁵ to 10⁶ cfu/ml of Staphylococcus aureus, Escherichia coli or other organism(s) under assessment and allowed to react with the dried antimicrobial formulation. Controls were used that contained no antimicrobial formulation so as to test viability of inoculum. At varied time intervals a sterile bacteriological loop was passed over the surface in 3 plains and then inoculated onto a TSA (trypticase soy blood agar) plate which was incubated over night in ambient air at 36° C. The assay intervals started at 30 min, then occurred as follows 1, 2, 3, 4, 5, 6, 8, 12 and 24 hours. Growth was recorded as follows: 4+(heavy growth, similar to starting control inoculum), 3+ moderately heavy growth (less than starting control inoculum), 2+ light growth (half or less than starting control inoculum), 1+ (scant growth), 0 (no growth). Residual activity was accessed accordingly.

| | | Listeria monocytogenes |
|---|---|---|
| Time | | Kill |
| 30 | min | 2+ |
| 1 | hour | 2 cfu |
| 2 | hours | 0 |
| 3 | hours | 0 |
| 5 | hours | 0 |
| 10 | hours | 0 |

These residual time to kill results indicate that the antimicrobial formulations of the present invention have a lasting efficacy after applied and dried and will continue to eradicate harmful microorganisms even when recontaminated. These results show that the peroxy antimicrobial of the present invention has residual efficacy.

These residual time to kill results indicate that the antimicrobial formulations of the present invention have a lasting efficacy after applied and dried and will continue to eradicate harmful microorganisms even when recontaminated. Also comparing examples 95 to 91 to 96 indicates that higher silver levels provide better residual efficacy results. These results indicate that a peroxy antimicrobial formulation of the present invention has residual efficacy.

### Example 97

Composition—about 0.1% Biosoft S101, 2.1% citric acid, 2.0% hydrogen peroxide, 0.6% peracetic acid, 750 ppm silver nitrate. A 250 ml beaker equipped with a magnetic stir bar was charged with 164.39 grams tap water containing 100 ppm sodium pyrophosphate and 0.23 grams of Biosoft S1101 surfactant are added and stirred at room temperature for 5 minutes to give a clear solution. Then 12.75 grams 30% hydrogen peroxide and stirred at room temperature for 5 minutes. Stirring was continued and 15.09 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 4.23 grams of citric acid was added and stirred for 5 minutes at room temperature. After dissolving the citric acid, 3.54 grams of 35% peracetic acid was added and stirred for 15 minutes at room temperature. Total of 200 grams with a pH of about 0.5 (pH paper measurement). This antimicrobial formulation was stored in a high density polyethylene bottles and is ready to use. This antimicrobial formulation is stable and does not degas or build up pressure upon storage.

### Example 98

Composition—about 0.1% Biosoft S101, 2.1% citric acid, 2.0% hydrogen peroxide, 0.6% peracetic acid, 750 ppm silver nitrate. A 250 ml beaker equipped with a magnetic stir bar was charged with 165.01 grams tap water containing 100 ppm acetanilide and 0.22 grams of Biosoft S1101 surfactant are added and stirred at room temperature for 5 minutes to give a clear solution. Then 12.67 grams 30% hydrogen peroxide and stirred at room temperature for 5 minutes. Stirring was continued and 15.05 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 4.25 grams of citric acid was added and stirred for 5 minutes at room temperature. After dissolving the citric acid, 3.43 grams of 35% peracetic acid was added and stirred for 15 minutes at room temperature. Total of 200 grams with a pH of about 0.5 (pH paper measurement). This antimicrobial formulation was stored in a high density polyethylene bottles and is ready to use. This antimicrobial formulation is stable and does not degas or build up pressure upon storage.

### Example 99

Composition—about 0.1% Biosoft S101, 2.1% citric acid, 2.0% hydrogen peroxide, 0.6% peracetic acid, 1000 ppm silver nitrate. A 250 ml beaker equipped with a magnetic stir bar was charged with 159.52 grams tap water containing 100 ppm acetanilide and 0.24 grams of Biosoft S101 surfactant are added and stirred at room temperature for 5 minutes to give a clear solution. Then 12.73 grams 30% hydrogen peroxide and stirred at room temperature for 5 minutes. Stirring was continued and 20.00 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 4.23 grams of citric acid was added and stirred for 5 minutes at room temperature. After dissolving the citric acid, 3.46 grams of 35% peracetic acid was added and stirred for 15 minutes at room temperature. Total of 200 grams with a pH of about 0.5 (pH paper measurement). This antimicrobial formulation was stored in a high density polyethylene bottles and is ready to use. This antimicrobial formulation is stable and does not degas or build up pressure upon storage.

### Example 100

Composition—about 0.1% Biosoft S101, 2.1% citric acid, 2.0% hydrogen peroxide, 0.6% peracetic acid, 750 ppm silver nitrate. A 250 ml beaker equipped with a magnetic stir bar was charged with 82.23 grams tap water containing 200 ppm sodium stannate and 0.12 grams of Biosoft S101 surfactant are added and stirred at room temperature for 5 minutes to give a clear solution. Then 6.35 grams 30% hydrogen peroxide and stirred at room temperature for 5 minutes. Stirring was continued and 7.51 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 2.12 grams of citric acid was added and stirred for 5 minutes at room temperature. After dissolving the citric acid, 1.79 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

### Example 101

Composition—about 0.1% Biosoft S101, 2.1% citric acid, 2.0% hydrogen peroxide, 0.6% peracetic acid, 1000 ppm silver nitrate. A 250 ml beaker equipped with a magnetic stir bar was charged with 79.79 grams tap water containing 200 ppm sodium stannate and 0.11 grams of Biosoft S101 surfactant are added and stirred at room temperature for 5 minutes to give a clear solution. Then 6.33 grams 30% hydrogen peroxide and stirred at room temperature for 5 minutes. Stirring was continued and 10.01 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 2.11 grams of citric acid was added and stirred for 5 minutes at room temperature. After dissolving the citric acid, 1.74 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

### Example 102

Composition—about 0.1% Biosoft S101, 2.1% citric acid, 2.5% hydrogen peroxide, 0.6% peracetic acid, 750 ppm silver nitrate. A 250 ml beaker equipped with a magnetic stir bar was charged with 82.39 grams of 3% hydrogen peroxide and 0.12 grams of Biosoft S101 surfactant are added and stirred at room temperature for 5 minutes to give a clear solution. Stirring was continued and 7.50 grams of a 1% aqueous silver nitrate solution (prepared by adding 0.5 grams of silver nitrate to 49.5 grams of water and manually stirred for 5 minutes at room temperature) was added and stirred at room temperature for 5 minutes. Stirring was continued and 2.13 grams of citric acid was added and stirred for 5 minutes at room temperature. After dissolving the citric acid, 1.79 grams of 35% peracetic acid was added and stirred for 15 minutes at room temperature. Total of 100 grams with a pH of about 0.5 (pH paper measurement). This antimicrobial formulation was stored in a high density polyethylene bottles and is ready to use. This antimicrobial formulation is stable and does not degas or build up pressure upon storage.

### Example 103

Composition—about 0.1% Biosoft S101, 2.1% citric acid, 2.0% hydrogen peroxide, 0.6% peracetic acid, 1000 ppm silver nitrate plus sodium chloride: A 16 ppm sodium chloride (typically found level in tap water); B=160 ppm sodium chloride (10 fold excess of what is typically found in tap water). The sodium chloride was added to composition of example 101.

Time to Kill Results for Example 103A—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

Time to Kill Results for Example 103B—diluted 1:2 with 4% protein broth. The results exemplify outstanding time to kill. These results also indicate that this antimicrobial maintains its efficacy even in the presence of protein or organic soil.

| Time (min) | S. aureus (cfu) | E. coli (cfu) |
|---|---|---|
| 1 | 0 | 0 |
| 5 | 0 | 0 |
| 10 | 0 | 0 |

These time to kill results indicate that the efficacy of the antimicrobial formulations of the present invention are not diminished by the presence of sodium chloride which would be expected to precipitate the silver as silver chloride out of the formulation.

The stock solution was the same for Examples 104 A, B, and C (6-38 a, b, d). This paragraph describes how the stock solution was made. A 500 ml beaker equipped with a magnetic stir bar was charged with 292.56 g distilled water, 0.55 grams of Biosoft S101 surfactant and 0.04 g of citric acid and stirred for 15 minutes until the surfactant was dissolved. Then 148.07 g of 30% hydrogen peroxide are added and stirred at room temperature for 5 minutes to give a clear solution. Stirring was continued and 8.76 g of 35% peracetic acid are added and stirred for 5 minutes to give a clear solution. Finally 50.05 g of butyl cellusolve are added and stirred for 15 minutes to give a clear solution. This is referred to as the stock solution. Using this stock solution, the examples were each prepared as described in the following paragraphs.

### Example 104A

Composition—about 0.1% Biosoft S101, 0.01% citric acid, 9.0% hydrogen peroxide, 0.6% peracetic acid, 0.3% benzoic acid, 5% boric acid, 10% butyl cellusolve. A 250 ml beaker equipped with a magnetic stir bar was charged with 100.03 g of the above stock solution and 0.31 g of benzoic acid and 4.99 g of boric acid are added and stirred for 1 hour to dissolve the solids.

### Example 104B

Composition—about 0.1% Biosoft S101, 0.01% citric acid, 9.0% hydrogen peroxide, 0.6% peracetic acid, 0.3% benzoic acid, 0.5% silver nitrate, 10% butyl cellusolve. A 250 ml beaker equipped with a magnetic stir bar was charged with 100.01 g of the above stock solution and 0.30 g of benzoic acid and 0.51 g of silver nitrate are added and stirred for 1 hour to dissolve the solids. hydrogen peroxide, 0.6% peracetic acid, 0.05% benzoic acid, 10% butyl cellusolve. A 250 ml beaker equipped with a magnetic stir bar was charged with 50 g of the above stock solution and 0.025 g of benzoic acid and stirred for 1 hour to dissolve the solids.

### Example 105B

Composition—about 0.1% Biosoft S101, 0.01% citric acid, 9.0% hydrogen peroxide, 0.6% peracetic acid, 0.1% silver nitrate, 10% butyl cellusolve. A 250 ml beaker equipped with a magnetic stir bar was charged with 50 g of the above stock solution and 0.05 g of silver nitrate and stirred for 1 hour to dissolve the solids.

### Example 105C

Composition—about 0.1% Biosoft S101, 0.01% citric acid, 9.0% hydrogen peroxide, 0.6% peracetic acid, 0.5% boric acid, 10% butyl cellusolve. A 250 ml beaker equipped with a magnetic stir bar was charged with 50 g of the above stock solution and 0.25 g boric acid and stirred for 1 hour to dissolve the solids.

### Example 105D

Composition—about 0.1% Biosoft S101, 0.01% citric acid, 9.0% hydrogen peroxide, 0.6% peracetic acid, 0.5% benzoic acid, 10% butyl cellusolve. A 250 ml beaker equipped with a magnetic stir bar was charged with 50 g of the above stock solution and 0.25 g benzoic acid and stirred for 1 hour to dissolve the solids.

### Example 105E

Composition—about 0.1% Biosoft S01, 0.01% citric acid, 9.0% hydrogen peroxide, 0.6% peracetic acid, 2.0% boric acid, 10% butyl cellusolve. A 250 ml beaker equipped with a magnetic stir bar was charged with 50 g of the above stock solution and 1.0 g boric acid and stirred for 1 hour to dissolve the solids.

### Example 105F

Composition—about 0.1% Biosoft S101, 0.01% citric acid, 9.0% hydrogen peroxide, 0.6% peracetic acid, 0.2% benzoic acid, 0.1% silver nitrate, 2.0% boric acid, 10% butyl cellusolve. A 250 ml beaker equipped with a magnetic stir bar was charged with 50 g of the above stock solution and 0.01 g benzoic acid, 0.05 g silver nitrate, 1.0 g boric acid and stirred for 1 hour to dissolve the solids.

### Example 105G

Composition—about 0.1% Biosoft S101, 0.01% citric acid, 9.0% hydrogen peroxide, 0.6% peracetic acid, 0.2% benzoic acid, 0.1% silver nitrate, 5.0% boric acid, 10% butyl cellusolve. A 250 ml beaker equipped with a magnetic stir bar was charged with 50 g of the above stock solution and 0.01 g benzoic acid, 0.05 g silver nitrate, 2.5 g boric acid and stirred for 1 hour to dissolve the solids.

### Example 105H

Composition—about 0.1% Biosoft S01, 0.01% citric acid, 9.0% hydrogen peroxide, 0.6% peracetic acid, 0.2% benzoic acid, 0.5% silver nitrate, 5.0% boric acid, 10% butyl cellusolve. A 250 ml beaker equipped with a magnetic stir bar was charged with 50 g of the above stock solution and 0.01 g benzoic acid, 0.25 g silver nitrate, 2.5 g boric acid and stirred for 1 hour to dissolve the solids.

### Example 106

Composition—about 0.5% Biosoft S101, 0.1% citric acid, 0.2% benzoic acid, 9.3% hydrogen peroxide, 0.6% peracetic acid, 4.0% boric acid, 0.5% silver nitrate, 10% butyl cellusolve.

A 250 ml beaker equipped with a magnetic stir bar was charged with 57.63 g distilled water, 0.53 grams of Biosoft S101 surfactant and 0.01 g of citric acid and stirred for 15 minutes until the surfactant was dissolved. Then 25.49 g of 35% hydrogen peroxide are added and stirred at room temperature for 5 minutes to give a clear solution. Stirring was continued and 4.10 g of 15% peracetic acid are added and stirred for 5 minutes to give a clear solution. Then 4.01 g boric acid and 0.53 g silver nitrate are added and stirred for 1 hour. Finally 10.04 g of butyl cellusolve are added and stirred for 15 minutes to give a clear solution. The pH is about 0.5 with pH paper.

The following procedure was used to test Examples 106 for residual efficacy. A sample, about 0.5 cc, of antimicrobial formulation 106 was coated on a petri dish to give about a 2 cm diameter circle of wetted area. The wet petri dish was allowed to air dry for about one hour. On to the center of the perti dish containing the different dried antimicrobial formulation was place about 0.1 cc of 100% aspergillus niger spores, about 1 colony forming units (cfu). The control was inoculated in the same fashion but had no antimicrobial formulation coating the petri dish. After one day the control showed significant growth and after 2 days the control showed significant growth which had spread beyond the initial zone of contact. No residual efficacy was observed with the control. In contrast the antimicrobial formulation of Example 106 showed no growth after one, two and three days. This result shows exceptional residual efficacy against hearty microorganisms such as aspergillus niger spores for the antimicrobial formulation of the present invention. Residual efficacy after a minimum of 1 day represents exceptional residual efficacy.

### Example 107

Composition—about 0.5% Biosoft S101, 0.1% citric acid, 0.2% benzoic acid, 9.3% hydrogen peroxide, 0.6% peracetic acid, 4.0% boric acid, 0.1% silver nitrate, 10% butyl cellusolve.

A 250 ml beaker equipped with a magnetic stir bar was charged with 27.88 g distilled water, 0.27 grams of Biosoft S101 surfactant and 0.01 g of citric acid and stirred for 15 minutes until the surfactant was dissolved. Then 12.72 g of 35% hydrogen peroxide are added and stirred at room temperature for 5 minutes to give a clear solution. Stirring was continued and 2.09 g of 15% peracetic acid are added and stirred for 5 minutes to give a clear solution. Then 2.01 g boric acid and 0.06 g silver nitrate are added and stirred for 1 hour. Finally 5.09 g of butyl cellusolve are added and stirred for 15 minutes to give a clear solution. The pH is about 0.5 with pH paper.

The following procedure was used to test Examples 107 for residual efficacy. A sample, about 0.5 cc, of antimicrobial formulation 107 was coated on a petri dish to give about a 2 cm diameter circle of wetted area. The wet petri dish was allowed to air dry for about one hour. On to the center of the perti dish containing the different dried antimicrobial formulation was place about 0.1 cc of 100% aspergillus niger spores, about 10⁵ colony forming units (cfu). The control was inoculated in the same fashion but had no antimicrobial formulation coating the petri dish. After one day the control showed significant growth and after 2 days the control showed significant growth which had spread beyond the initial zone of contact. No residual efficacy was observed with the control. In contrast the antimicrobial formulation of Example 107 showed no growth after one day. After 2 days 5 cfu of aspergillus niger were observed. This result shows residual efficacy against hearty microorganisms such as aspergillus niger spores for the antimicrobial formulation of the present invention. Residual efficacy after a minimum of 1 day represents exceptional residual efficacy.

The stock solution described in this paragraph was prepared for examples 108 A-D. A 500 ml beaker equipped with a magnetic stir bar was charged with 237.39 g tap water, 0.30 grams of Biosoft S101 surfactant and 12.24 g of citric acid and stirred for 15 minutes until a solution formed. Then 0.02 g of silver nitrate are added and stirred at room temperature for 5 minutes to give a clear solution with a pH of about 2. This is referred to as the stock solution. Other silver salts or electrolytic methods can also be used to introduce the silver into these formulations. Using this stock solution, the examples were each prepared as described in the following paragraphs.

### Example 108A

Composition—about 0.1% Biosoft S101, 0.007% silver nitrate, 4.30% citric acid, 1.90% hydrogen peroxide. This formulation was prepared by placing 50.00 g of the above stock solution into a polyethylene bottle and then adding 2.91 g of 35% hydrogen peroxide. The contents were hand swirled for 2 minutes to give a homogeneous solution with a pH of about 2.0.

### Example 108B

Composition—about 0.1% Biosoft S101, 0.007% silver nitrate, 4.30% citric acid, 1.80% hydrogen peroxide and 0.50% peracetic acid. This formulation was prepared by placing 50.54 g of the above stock solution into a polyethylene bottle and then adding 2.93 g of 35% hydrogen peroxide and 0.85 g of 35% peracetic acid. The contents were hand swirled for 2 minutes to give a homogeneous solution with a pH of about 0.5.

### Example 108C

Composition—about 0.1% Biosoft S101, 0.007% silver nitrate, 4.30% citric acid, 1.80% hydrogen peroxide, 0.50% peracetic acid and 4.4% butyl cellusolve. This formulation was prepared by placing 50.11 g of the above stock solution into a polyethylene bottle and then adding 2.96 g of 35% hydrogen peroxide, 0.87 g of 35% peracetic acid, and 2.51 g butyl cellusolve. The contents were hand swirled for 2 minutes to give a homogeneous solution with a pH of about 0.5.

### Example 108D

Composition—about 0.1% Biosoft S101, 0.006% silver nitrate, 4.10% citric acid, 5.20% hydrogen peroxide, 0.51% peracetic acid and 4.4% butyl cellusolve. This formulation was prepared by placing 50.13 g of the above stock solution into a polyethylene bottle and then adding 9.05 g of 35% hydrogen peroxide, 0.87 g of 35% peracetic acid, and 2.51 g butyl cellusolve. The contents were hand swirled for 2 minutes to give a homogeneous solution with a pH of about 0.5.

These examples show that the antimicrobial formulations of the present invention can be prepared with various levels of silver, boric acid, organic acid with various levels of surfactant, with various levels of peroxy agents using plain tap water with or without peroxy stabilizers. The peroxy agents may be incorporated into the formulation either before or after the introduction of the silver or boric acid components.

The test results described above were achieved using dodecylbenzene sulfonic acid as the surfactant. Additional tests were performed to prove that other surfactants exhibit the same or similar efficacy in these formulations as the dodecylbenzene sulfonic acid. The tests described below include examples. The surfactants that may be used in the formulation include, but are not limited to, dodecylbenzene sulfonic acid and the specific surfactants used below.

### Example 110A

About 9% hydrogen peroxide, 0.6% peracetic acid, 0.01% citric acid, 0.2% benzoic acid, 10% butyl cellusolve, 0.2% sodium lauryl sulfate. A 250 ml beaker equipped with a magnetic stir bar was charged with 27.09 g of tap water, 0.12 g sodium lauryl sulfate, 0.01 g citric acid and 0.09 g benzoic acid. The mixture was stirred for 30 minutes at room temperature and some small amount of benzoic acid remains undissolved. Then 0.99 g boric acid is added and stirred for 10 minutes at room temperature. To the beaker is then added 12.31 g of 35% hydrogen peroxide, stirred 5 minutes followed by the addition of 2.07 g of 15% peracetic acid and stirred at room temperature for 5 minutes. Finally 5.01 g of butyl cellusolve is added and stirred at room temperature for 15 minutes. The pH is approximately 0.5 measured by pH paper. Some benzoic acid remains undissolved but upon standing overnight at room temperature (approximately 19 hours) becomes completely dissolved.

### Example 110B

About 9% hydrogen peroxide, 0.6% peracetic acid, 0.01% citric acid, 0.2% benzoic acid, 10% butyl cellusolve, 1.2% lauryl 3 ethoxylate sodium sulfate (available as Polystep B12 from Stepan).

A 250 ml beaker equipped with a magnetic stir bar was charged with 27.02 g of tap water, 1.02 g lauryl 3 ethoxylate sodium sulfate—Polystep B-12 (59%), 0.01 g citric acid and 0.11 g benzoic acid. The mixture was stirred for 30 minutes at room temperature and some small amount of benzoic acid remains undissolved. Then 1.01 g boric acid is added and stirred for 10 minutes at room temperature. To the beaker is then added 12.35 g of 35% hydrogen peroxide, stirred 5 minutes followed by the addition of 2.03 g of 15% peracetic acid and stirred at room temperature for 5 minutes. Finally 5.03 g of butyl cellusolve is added and stirred at room temperature for 15 minutes. The pH is approximately 0.5 measured by pH paper. Some benzoic acid remains undissolved but upon standing overnight at room temperature (approximately 19 hours) becomes completely dissolved.

### Example 110C

About 9% hydrogen peroxide, 0.6% peracetic acid, 0.01% citric acid, 0.2% benzoic acid, 10% butyl cellusolve, 3.0% nonionic ethylene oxide—propylene oxide block copolymer surfactant (available as Pluronic® L-43 from BASF).

A 250 ml beaker equipped with a magnetic stir bar was charged with 27.04 g of tap water, 1.55 g ethylene oxide—propylene oxide block copolymer surfactant—Pluronic® L-43, 0.01 g citric acid and 0.10 g benzoic acid. The mixture was stirred for 30 minutes at room temperature and some small amount of benzoic acid remains undissolved. Then 0.99 g boric acid is added and stirred for 10 minutes at room temperature. To the beaker is then added 12.36 g of 35% hydrogen peroxide, stirred 5 minutes followed by the addition of 2.04 g of 15% peracetic acid and stirred at room temperature for 5 minutes. Finally 5.07 g of butyl cellusolve is added and stirred at room temperature for 15 minutes. The pH is approximately 0.5 measured by pH paper. Some benzoic acid remains undissolved but upon standing overnight at room temperature (approximately 19 hours) becomes completely dissolved.

### Example 110D

About 9% hydrogen peroxide, 0.6% peracetic acid, 0.01% citric acid, 0.2% benzoic acid, 10% butyl cellusolve, 3.0% nonionic alkyl aryl ethoxylated surfactant (available as Triton™ X114 from Dow). A 250 ml beaker equipped with a magnetic stir bar was charged with 27.01 g of tap water, 1.52 g nonionic alkyl aryl ethoxylate surfactant—Triton™ X114, 0.01 g citric acid and 0.12 g benzoic acid. The mixture was stirred for 30 minutes at room temperature and some small amount of benzoic acid remains undissolved. Then 1.00 g boric acid is added and stirred for 10 minutes at room temperature. To the beaker is then added 12.29 g of 35% hydrogen peroxide, stirred 5 minutes followed by the addition of 2.03 g of 15% peracetic acid and stirred at room temperature for 5 minutes. Finally 5.04 g of butyl cellusolve is added and stirred at room temperature for 15 minutes. The pH is approximately 0.5 measured by pH paper. Some benzoic acid remains undissolved but upon standing overnight at room temperature (approximately 19 hours) becomes completely dissolved.

### Example 110E

About 9% hydrogen peroxide, 0.6% peracetic acid, 0.01% citric acid, 0.2% benzoic acid, 10% butyl cellusolve, 0.5% disodium lauryl sulfosuccinate. A 250 ml beaker equipped with a magnetic stir bar was charged with 26.99 g of tap water, 0.27 g disodium lauryl sulfosuccinate, 0.01 g citric acid and 0.11 g benzoic acid. The mixture was stirred for 30 minutes at room temperature and some small amount of benzoic acid remains undissolved. Then 1.03 g boric acid is added and stirred for 10 minutes at room temperature. To the beaker is then added 12.34 g of 35% hydrogen peroxide, stirred 5 minutes followed by the addition of 2.05 g of 15% peracetic acid and stirred at room temperature for 5 minutes. Finally 5.03 g of butyl cellusolve is added and stirred at room temperature for 15 minutes. The pH is approximately 0.5 measured by pH paper. Some benzoic acid remains undissolved but upon standing overnight at room temperature (approximately 19 hours) becomes completely dissolved.

These examples demonstrate that in addition to alkyl benzene sulfonates, other surfactants such as alkyl sulfates, alkyl ethoxylated sulfates, nonionic block copolymers, nonionic alkylaryl ethoxylates and alkyl sulfosuccinates can be used to prepare formulations of the present invention. These examples are representative of a broad range of surfactants and demonstrate the broad scope of surfactants which have utility in the present invention.

These antimicrobial formulations of the present invention have a multiplicity of attributes: outstanding broad spectrum efficacy with rapid time to kill features; are easy to prepare or manufacture and do not require purified water, instead normal tap water can be used; are stable, a stable one package multicomponent formulation; use readily available and easy to handle chemical components; are easy to use or apply, no special equipment or training required; are rapid acting broad spectrum antimicrobials that are bactericidal, fungicidal, mycobactericidal, viricidal, protozoacidal, sporocidal, and eradicate biofilms; are not detrimental to individuals using the antimicrobial; leave no toxic residues; are not detrimental to materials of construction for the items, articles and surfaces being treated, including metals and synthetic materials; while in addition having residual activity to prevent the rapid reoccurrence of harmful microorganisms on the items, articles or surfaces that have been treated. The formulations of the present invention have residual efficacy against aspergillus niger spores for at least 1 day. It is preferred that the formulations of the present invention have residual efficacy against aspergillus niger spores for at least 2 days. It is most preferred that the formulations of the present invention have residual efficacy against aspergillus niger spores for at least 3 days.

In addition the antimicrobial formulations of the present invention do not have a negative impact on the environment. The peroxy compounds used revert to water, oxygen and acetic acid and are considered environmentally green. This list of attributes for the antimicrobial formulations of the present invention is far beyond the current state of the art upon which current commercial antimicrobials are based.

This high degree of efficacy for the antimicrobial formulations of the present invention is due to the multiple modes of antimicrobial action: disruption of cell membranes and loss of life supporting semipermeability, efficient oxidative inactivation of cells—of both enzymes and proteins critical for structural integrity and metabolic processes, denaturing of proteins and DNA which prevents the continuation of life supporting processes and replication, functional group modification preventing continuation of life supporting processes, rapid destruction of protective layers especially important in eradicating spore forms of microorganisms.

This impressive list of modes of action also insures that the microorganism will not develop a resistance to antimicrobial formulations of the present invention.

This entire list of attributes found in the antimicrobial formulations of the present invention have not previously been achieved in a single antimicrobial formulation.

Availability of formulation ingredients: Pluronic® and Tetronic® surfactants BASF Corporation; Triton™ surfactants—Dow Chemical Company; BioSoft S101—Stepan Company; Citric acid (other acids or salts)—Sigma Aldrich; Silver nitrate—Sigma Aldrich, Salt Metals ETS Inc.; Hydrogen Peroxide solutions, 3% or 30% or 35%—Sigma Aldrich, Cumberland Swan, Degussa, Solvay, FMC Corporation; Peracetic acid —FMC Corporation, Sigma Aldrich, Thermo-Fischer; Peroxy compounds—Arkema Inc.

I claim:

1. A composition, comprising:
a quick kill component, wherein the quick kill component is able to kill organisms selected from the group consisting of bacteria, viruses, fungi, mold, spore-forming bacteria and combinations thereof, and
a residual kill component, wherein the residual component has a residual efficacy against spores or bacteria or viruses for at least one day.

2. The composition of claim 1, wherein the quick kill component includes a peroxy based composition.

3. The composition of claim 1, wherein the residual kill component includes a component having silver, boron, copper, or combinations thereof.

4. The composition of claim 1, wherein the residual kill component has residual efficacy against aspergillus niger spores for at least one day.

5. The composition of claim 1, wherein the residual kill component has residual efficacy against aspergillus niger spores for at least two days.

6. The composition of claim 1, wherein the residual kill component has residual efficacy against aspergillus niger spores for at least three days.

7. The composition of claim 1, wherein the composition is effective to exhibit a time to kill of 5 minutes or less and preferably a time to kill of 1 minute or less against each of Staphylococcus aureus ATCC 6538, Escherichia coli ATCC 8739 when diluted 1 to 2 with a 4% human protein broth.

8. The composition of claim 1, wherein the composition is an antimicrobial composition.

9. The composition of claim 1, wherein the composition is an anti-corrosion composition.

10. A composition, comprising:
at least one surfactant present in a concentration from about 0.01% to about 80% by weight;
an acid or acid salt present in a concentration of from about 0.01% to about 20% by weight;
at least one peroxide in a concentration of from about 0.01% to about 55% by weight;
at least one peracid in a concentration of from about 0.01% to about 30% by weight;
at least one source of silver, boron or copper salt, or combinations thereof in a concentration of from about 0.01% to about 10% by weight; and
the balance water.

11. The composition of claim 10, wherein the composition further comprises the use of at least one water soluble solvent in a concentration of about 0.01% to about 20%

12. The composition of claim 10, wherein the surfactant is anionic or nonionic.

13. The composition of claim 1, wherein the surfactant is about 0.1% to about 2% dodecylbenzene sulfonic acid.

14. The composition of claim 10, wherein the acid is from about 0.01% to about 5.0% citric acid.

15. The composition of claim 10, wherein the peroxide is from about 1.0 to about 10.0% hydrogen peroxide.

16. The composition of claim 10, wherein the at least one source of silver, boron or copper salt, or combinations thereof is silver and the concentration is from about 1000 ppm to about 0.5% of silver nitrate.

17. The composition of claim 10, wherein the at least one source of silver, boron or copper salt, or combinations thereof is from about 1000 ppm to about 0.5% of silver nitrate and about 2.0% to about 6.0% boric acid.

18. The composition of claim 10, wherein the peracid is about 0.05 to 6.0% peric acid.

19. The composition of claim 10, wherein the composition includes a wetting agent.

20. The composition of claim 10, wherein the water is tap water.

21. The composition of claim 10, wherein a. The antimicrobial composition of claim 1 which comprises about 0.1% dodecylbenzene sulfonic acid, about 2% citric acid, about 2% hydrogen peroxide, about 0.6% peracetic acid and about 1000 parts per million (ppm) silver nitrate.

22. The composition of claim 10, which comprises about 0.1% dodecylbenzene sulfonic acid, about 3% citric acid, about 3% hydrogen peroxide, about 3% peracetic acid and about 1000 parts per million (ppm) silver nitrate.

23. The composition of claim 10 which comprises about 2% dodecylbenzene sulfonic acid, about 0.1% citric acid, about 2% hydrogen peroxide, about 0.6% peracetic acid and about 1000 parts per million (ppm) silver nitrate.

24. The composition of claim 10 which comprises about 0.5% dodecylbenzene sulfonic acid, about 0.01% citric acid, about 9.3% hydrogen peroxide, about 0.6% peracetic acid, about 0.2% benzoic acid, about 4% boric acid, about 10% butyl cellusolve and about 0.5% silver nitrate.

25. The composition of claim 10 which comprises about 0.5% dodecylbenzene sulfonic acid, about 0.01% citric acid, about 9.3% hydrogen peroxide, about 0.6% peracetic acid, about 0.2% benzoic acid, about 4% boric acid, about 10% butyl cellusolve and about 0.1% silver nitrate.

26. The composition of claim 10 which comprises about 0.5% dodecylbenzene sulfonic acid, about 0.01% citric acid, about 9.3% hydrogen peroxide, about 0.6% peracetic acid, about 0.2% benzoic acid, about 4% boric acid, about 10% butyl cellusolve and about 0.1% silver nitrate.

27. The composition of claim 10 which comprises about 0.1% dodecylbenzene sulfonic acid, about 0.01% citric acid, about 9.0% hydrogen peroxide, about 0.6% peracetic acid, about 0.3% benzoic acid, about 5.0% boric acid and about 10.0% butyl cellusolve.

28. The composition of claim 10 which comprises about 0.1% dodecylbenzene sulfonic acid, about 0.01% citric acid, about 9.0% hydrogen peroxide, about 0.6% peracetic acid, about 0.3% benzoic acid, 0.5% silver nitrate and about 10.0% butyl cellusolve.

29. The composition of claim 1 which comprises about 0.1% dodecylbenzene sulfonic acid, about 0.01% citric acid, about 9.0% hydrogen peroxide, about 0.6% peracetic acid, about 0.3% benzoic acid, 5.0% boric acid, 0.5% silver nitrate and about 10.0% butyl cellusolve.

30. The composition of claim 1 which comprises about 0.1% dodecylbenzene sulfonic acid, about 4.3% citric acid, about 5.2% hydrogen peroxide, about 0.5% peracetic acid and about 0.006% silver nitrate.
